(19) United States
(12) Patent Application Publication
(10) Pub. No.: US 2012/0259787 A1
(43) Pub. Date: Oct. 11, 2012

(54) PATENT CLAIM MATRIX AND NON-LITERAL INFRINGEMENT

(76) Inventor: Gary J. Speier, Eden Prairie, MN (US)

(21) Appl. No.: 13/083,749

(22) Filed: Apr. 11, 2011

(51) Int. Cl. G06Q 50/00

(52) U.S. Cl. 705/310

(57) ABSTRACT

Various embodiments include methods and systems for a patent claim matrix and non-literal infringement analysis. A patent claim can be determined that a target technology does not literally infringe. A prior version of the patent claim can be determined that the target technology does literally infringe. A user interface can then be presented to show a user that the target technology does not infringe the claim based on the doctrine of equivalents.

### TECHNICAL FIELD

This document pertains generally to patent claim analysis, and more particularly, but not by way of limitation, to patent claim matrix and non-literal infringement.

### BACKGROUND

Patent claim analysis is typically performed by attorneys and companies for various purposes, such as prior art searching, validity analysis, or freedom to operate investigations. Often, an individual will perform a patent search and sift through a large number of claims to identify claims relevant to the particular purpose for which the patent claim analysis is being performed. Once relevant claims are identified, the individual may attempt to represent the relevant claims in a particular way to facilitate the claim analysis.

Tools to assist an individual performing patent analysis can include patent search tools, claim extraction tools to extract claims from the found patents, and formatting tools to, for example, place the extracted claims in a table. Generally, further analysis of the claims to, for example, determine if one is infringed, involves a manual process by which the individual performing the analysis makes many subjective decisions in comparing the claims to a possible infringer. This manual process can introduce several problems, including a heavy reliance on the ability of the individual to make correct and consistent subjective decisions. Moreover, the problems can be complicated when more than one individual is involved in the process. Because the decisions are subjective, even two competent individuals can embark upon inconsistent positions and hurt the claim analysis. Further, to maintain consistency across those performing the claim analysis, a tremendous amount of time may be devoted to the analysis on top of the significant time spent to perform the analysis itself.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of example components to a system for a patent claim matrix and non-literal infringement analysis, according to one embodiment.

FIGS. 2A-2B illustrate Euler diagrams of the relationship between a target technology and a patent claim for infringement analysis, according to one embodiment.

FIG. 3 illustrates an example user interface for presenting an analysis of non-infringement under the Doctrine of Equivalents, according to one embodiment.

FIG. 4 illustrates an example user interface for presenting an analysis of non-infringement under the Doctrine of Equivalents, according to one embodiment.

FIG. 5 illustrates an example user interface with a claim matrix, according to one embodiment.

FIG. 6 illustrates an example user interface with claim matrix including scope concept visual components, according to one embodiment.

FIGS. 7A-7B illustrate different views of an example user interface with claim matrix as claim elements are collapsed into a scope concept, according to one embodiment.

FIG. 8 illustrates an example method to determine non-literal non-infringement, according to one embodiment.

FIG. 9 illustrates an example method of updating a scope concept visual component with a summary of the claim elements associated with the scope concept, according to one embodiment.

FIGS. 10A-10B illustrate an example method to automatically update a claim matrix to allow quick identification of literal infringement.

FIG. 11 illustrates an example method of ordering visual representations of claims in a claim matrix, according to one embodiment.

FIG. 12 illustrates a block diagram of an example machine upon which any one or more of the methodologies discussed may be run.

### DETAILED DESCRIPTION

An important use for patent analysis is in determining whether a target technology infringes a patent. Typically, after a patent search has been performed, a professional extracts the claims from the search results and compares them to a target technology. Infringement analysis in this regime can be an intensive, time consuming process in which many human errors can be injected.

The infringement analysis process can be significantly improved through a visual representation of the target technology vis-à-vis the found patent claims that allows quick determination of the relevance of any found patent claim with respect to the infringement analysis. One way in which the visual representation can be effective towards this end is to graphically show which claim elements are part of a claim infringed by the target technology, which claim elements are present in the target technology and a claim the target technology does not infringe, and which claim elements are not present in the target technology. By focusing on the claim elements, and incorporating them where appropriate when defining the target technology, the process by which the three categories of claim amendments are found and graphically indicated can be automated. This automation is not only quick, but removes human error and possibly inconsistent subjective decision making from determining what patent claims a target technology may infringe, and what parts of the patent claims could present difficulties if more claim elements are added to the target technology definition.

Directly comparing claim elements in a target technology with the found claims can quickly yield indications of the patent claims that the target technology may literally infringe. However, even if a target technology does not literally infringe a patent claim, the target technology may nonetheless infringe under the doctrine of equivalents (DOE). Generally, the DOE attempts to include insubstantial variations of the literal language of a claim. For example, if a claim recites Element A, and a target technology includes Element B, and Element B performs substantially the same function, in substantially the same way, to yield substantially the same result, then Element B would be considered to infringe Element A even if Element A does not literally describe element B. Determining infringement under the DOE generally requires more analysis, and subjective decision making, by a professional because considerations external to the literal language of the claim become more important.

The DOE includes an exception which, when properly considered, allows the use of an automatic process to identify claims that are not infringed by the target technology under the DOE. Generally, as a patent claim is prosecuted (e.g., examined by the USPTO), an applicant may amend the claim to narrow the scope of the claim. The courts have noted that where an applicant amended the subject matter of a claim, often to avoid prior art introduced in prosecution, the applicant cannot later reassert that subject matter forfeited by the amendment is nonetheless covered under the DOE. That is, if the claim once covered subject matter, and later did not cover that subject matter due to amendment, then the target technology does not infringe the claim under the DOE if it includes the forfeited subject matter. This determination can be made automatically by using the automatic process for determining literal infringement described above. First, if it is determined that the target technology does not literally infringe the claim, prior versions of the claim can be sought. The automatic literal infringement analysis can be applied to each of these prior versions. If a prior version of the patent claim is found that the target technology would have literally infringed, then a conclusion can be made that subject matter was forfeited between the prior patent claim and the current patent claim. Because the target technology literally infringed the prior patent claim, but not the current, it can be concluded that the target technology falls into the forfeited subject matter, and so the DOE cannot be applied to argue that the target technology infringes the patent claim. Thus, not only can literal infringement be automatically determined to quickly compare a target technology against many claims, but also some forms of non-literal infringement can be automatically determined.

Once literal and non-literal infringement of the target technology vis-à-vis the claims are automatically determined, this data can be presented to a user in such a way as to allow quick identification of claims, and claim elements, that may present issues for the target technology. One example presentation is a claim matrix (or claim chart) identifying the claim elements, the claim elements present in the target technology, and the claim elements present in the patent claims that are either also found in the target technology or not found in the target technology. The claim elements found in the target technology can be further identified as claim elements belonging to a claim literally infringed by the target technology or claim elements belonging to a claim that is not literally infringed by the target technology.

The identification of claim elements can be visually represented to quickly convey the type of claim element. For example, claim elements in a claim literally infringed by the target technology can be in red, or include some other indication that they need to be seriously considered. Claim elements in a claim but not in the target technology can be in green, or include some other visual indication that they are not relevant to the infringement analysis of the target technology. Charting these claim elements with respect to the claims to which they belong allows users performing infringement analysis to quickly identify patents that are, and those that are not, relevant. Moreover, a degree of relevance can also be quickly determined by noting, for example, the number of green elements in a particular patent claim, where the greatest number of green elements indicates the greatest number of claim elements that the target technology would have to add before literally infringing the claim. To further facilitate the user's determination of relevance, the visual representations of the claims themselves (e.g., columns in the claim matrix) can be ordered based on this degree of relevance, or degree of infringement, which can be automatically calculated based on the claim elements common, and not common, between the target technology and the patent claims.

Often, if the target technology is complex, the number of elements is large, or if a variety of differing claim elements are equivalent, it can be useful to provide the additional concept of a scope concept. A scope concept can include a broader description encompassing one or more claim elements. A user can create scope concepts and associate claim elements to the scope concept such that minor differences between claim elements can be effectively managed. To facilitate the use of scope concepts, the claim matrix can include a visual representation of the scope concept. This visual representation can be used to quickly add or subtract the associated claim elements to the target technology definition. It can also allow the visual representations of the claim elements (e.g., rows in the claim matrix) to be hidden. When these rows are hidden, the previously mentioned benefit of color-coding the relationship between the target technology and a given patent claim may be lost. However, changing the visual representation of the scope concept to summarize the now hidden rows can solve this problem. For example, if a claim scope was associated with claim elements for a patent claim literally infringed by the target technology, the scope concept can include the visual representation of this relationship. For example, if the relationship is marked by a red cell at the intersection of the claim element and the patent claim, the cell at the intersection of the scope concept and the patent claim can be turned red when the row is hidden. If there are a variety of relationships represented by the hidden rows, the scope concept can prioritize them and represent the highest priority relationship. For example, if the scope concept summarizes claim elements that are literally infringed (red) and claim elements that are not infringed (green), the summary will display in red to indicate that at least some of the summarized claim elements are literally infringed. In this way, the appropriate signal can still be conveyed to the user even when the claim elements themselves are not visible.

By introducing a process that can be automated and by which a target technology can be determined to literally infringe or not infringe under the DOE, performing infringement analysis can be more efficient and reduce human error. Further, by providing a visual representation of the analysis that can allow quick and easy determination of the automatic infringement conclusions, a user can even more quickly provide the insightful analysis important to today's businesses.

Methods and systems for a patent matrix and non-literal infringement analysis are herein described. In the following description, for purposes of explanation, numerous specific details are set forth in order to provide a thorough understanding of the various aspects of different embodiments of the present subject matter. It will be evident, however, to one skilled in the art, that the present subject matter may be practiced without these specific details.

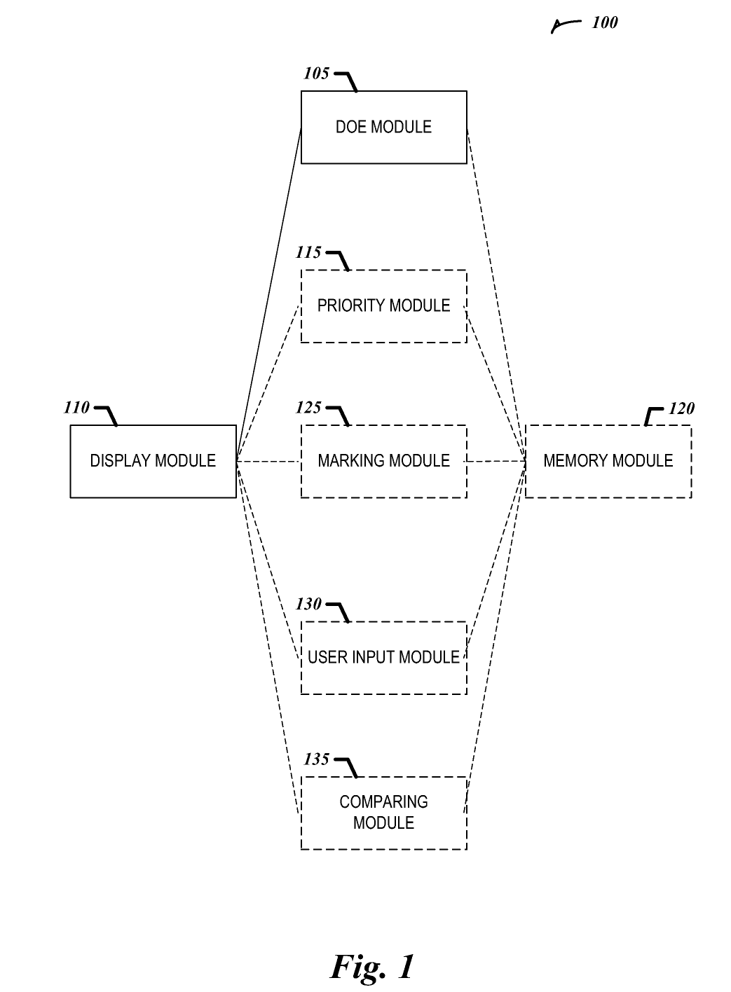

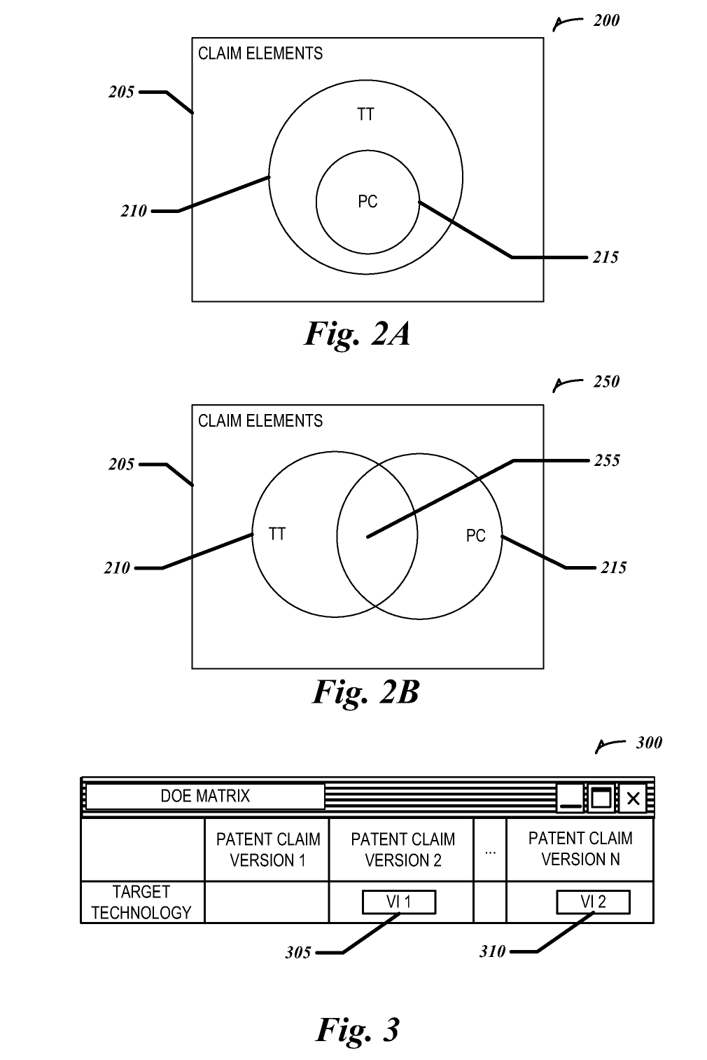

FIG. 1 illustrates a block diagram of example components to a system 100 for a patent claim matrix and non-literal infringement analysis, according to one embodiment. FIGS. 2A-7B variously illustrate example set configurations and user interfaces that the components described below can either use or produce. As such, FIGS. 2A-7B will be introduced within the following discussion of the example system 100.

In some examples, system 100 can include a DOE module 105, a display module 110, a priority module 115, a memory module 120, a marking module 125, a user input module 130, and a comparing module 135. In this example, the DOE module 105 and the display module 110 can be used for non-literal infringement analysis. In some examples, the memory module 120, marking module 125, and user input module 130 can be added to the display module 110 present and manipulate a claim matrix. In some examples, the priority module 115 can be added to the display module 110 and the user input module 130 to provide additional scope concept functionality to the claim matrix. In some examples, the comparing module 135 can be added to the display module to provide a degree of infringement ordering capability to the claim matrix.

As previously discussed, an important consideration in an infringement analysis is not only determining literal infringement of a patent claim by a target technology, but determining infringement under the DOE. To facilitate this determination, the system 100 can include a DOE module 105 communicatively coupled to a display module 110.

The DOE module 105 can be configured to receive a plurality of patent claim versions for a patent claim. That is, the patent claim versions in the plurality of patent claim versions are different versions of the same patent claim. In some examples, the sameness of the patent claim across versions can be determined by the claim number in a patent application. In some examples, the patent claim versions in the plurality of versions are differentiated via the time of their entry. That is, one version can be the original patent claim as filed, and another version occurs after an amendment has been entered. Patent claims are commonly amended one or more times during the course of examination within the USPTO. In some examples, a new version of a patent claim occurs after an applicant proposed amendment has been entered, or after an Examiner's amendment has been ratified by an applicant. In some examples, each version of the patent claim can include one or more claim elements. In some examples, a claim element is an item, step, or other feature of a patent claim by which infringement can be judged. In some examples, the DOE module 105 can be further configured to identify a patent claim version set (PCV set) corresponding to each patent claim version in the plurality of patent claim versions (i.e., one PCV set per patent claim version), with each PCV set including one or more claim elements. Thus, given two versions of a single patent claim, the DOE module 105 can identify a first PCV set including the claim elements of one version and a second PCV set including the claim elements of the second version.

The DOE module 105 can also be configured to receive a target technology definition for a target technology. In some examples, the target technology definition can be a set of claim elements. That is, the target technology can be defined, at least in part, by the claim elements that describe the target technology. In some examples, the claim elements are taken from a library of claim elements. In some examples, the library of claim elements includes the claim elements of the patent claim. In some examples, the library of claim elements includes claim elements from other claims that may be included in a broader infringement analysis of the target technology. In some examples, the library of claim elements can include elements derived from outside sources, such as technical manuals, academic papers, or other sources that provide descriptions that are likely relevant to the infringement analysis. In some examples, the DOE module 105 can be further configured to identify the target technology set (TT set) in the target technology definition. In this case, the TT set can include one or more of the claim elements.

The DOE module 105 can also be configured to generate a DOE indication based on the plurality of versions of the patent claim and the target technology definition. In some examples, the DOE indication can be of a first type if the target technology does not infringe the patent claim under the DOE and of a second type otherwise. The first type of DOE indication can establish that the target technology does not infringe the patent claim based on the doctrine of equivalents.

In some examples, the determination that the target technology does not infringe the patent claim based on the DOE is based on the observation that where a patent applicant carves out, or excludes, subject matter from a patent claim, the applicant cannot later argue that the forfeited subject matter is covered by the patent claim under the DOE. The determination can be made automatically by using a literal infringement analysis based on the claim elements in the TT set and at least two PCV sets. In some examples, literal infringement of a patent claim version by the target technology can be assessed by determining whether the corresponding PCV set is a subset—as used herein “subset” refers to both a proper subset and an equal set; that is, given subset A to set B, A⊂B—of the TT set. This is illustrated in the Euler diagram 200 shown in FIG. 2A. Here, the PCV set 215 is a subset of the TT set 210. Note that both the TT set 210 and the PCV set 215 are in the universe of claim elements 205. In some examples the universe of claim elements 205 can be the library of claim elements discussed above. Generally, when a set of elements representing a patent claim, or patent claim version, is a subset of the TT set 210 (or similar construct in which the definition of the target technology in the infringement analysis is based on claim elements), the target technology literally infringes the patent claim.

In contrast to the literal infringement of a patent claim (or version) illustrated in the Euler diagram 200, the Euler diagram 250, shown in FIG. 2B, illustrates non-literal infringement of a patent claim by the target technology. Here, within the universe of claim elements 205, the PCV set 215 is not a subset of the TT set 210. Thus, a determination can be made that, as shown in diagram 250, the target technology does not literally infringe the patent claim version. However, as suggested above, the DOE can possibly be used to establish the infringement of the patent claim version by the target technology using a determination that one or more elements of the target technology are equivalents of one or more claim elements in the patent claim version. An instance in which the DOE cannot later establish infringement by the target technology is in the case of the patent claim's applicant forfeiting subject matter in the prosecution of the patent claim. Here, the applicant's action to exclude subject matter acts as a bar to prevent the applicant from reclaiming the forfeited subject matter.

When a patent claim is analyzed in a broader infringement analysis, it may be identified as not literally infringed by the target technology using the procedure described above. The DOE module 105 can then, in some examples, be configured to use the received versions of the patent claim and analyze them for literal infringement by the target technology. If a prior version of the patent claim is determined to be literally infringed by the target technology, then it is known that the patent claim's applicant forfeited subject matter, reflected in the target technology, and thus cannot later establish coverage of that subject matter using the DOE for the patent claim. To this end, in some examples, the DOE module 105 can be configured to receive a first patent claim version and a second patent claim version from the plurality of patent claim versions. The DOE module 105 can then be configured to determine that the target technology literally infringes the first patent claim version and also determine that the target technology does not literally infringe the second patent claim version. In some examples, the DOE module 105 can be configured to determine that the first version of the patent claim chronologically precedes the second version of the patent claim. In some examples, the first type of DOE identification can include an identification of the first version of the patent claim. In some examples, the first type of DOE identification can include an identification of the second version of the patent claim. Thus, the first type of DOE identification is a marker that the target technology does not infringe the patent claim under the DOE, and can also identify the specific patent claim versions giving rise to this determination. Such information can support later visual representations of the automatic analysis, as well as provide auditing information to help users verify the analysis.

The system 100 can also include the display module 110. The display module 110 can be configured to present a user interface. In some examples, the user interface can include a visual indicator of the DOE indication. An example user interface 300 is shown in FIG. 3. The user interface 300 can be a matrix where the target technology is represented as a row and columns corresponding to patent claim versions one, two, through patent claim version n. In user interface 300, the visual indicator of the DOE identification can be shown as sub-indicators “VI 1” 305 and “VI 2” 310. In this example, sub-indicator 305 can correspond to the patent claim version literally infringed (e.g., as identified in the DOE identification) by the target technology. Also, sub-indicator 310 can correspond to the patent claim version not literally infringed by the target technology. In some examples, the literal infringement visual sub-indicator 305 (or visual indicator generally) can be in red, or other color (e.g., orange) representative as an alert (e.g., the user should take notice) to the user. In some examples, the lack of literal infringement visual sub-indicator 305 (or visual indicator generally) can be in green or in another color representative of a condition acceptable (e.g., the user need not apply excessive scrutiny) to the user. Other visual symbols can also be used to convey the alert or acceptable conditions, such as a stop sign icon for the alert or a green light, or check mark, icon for the acceptable condition.

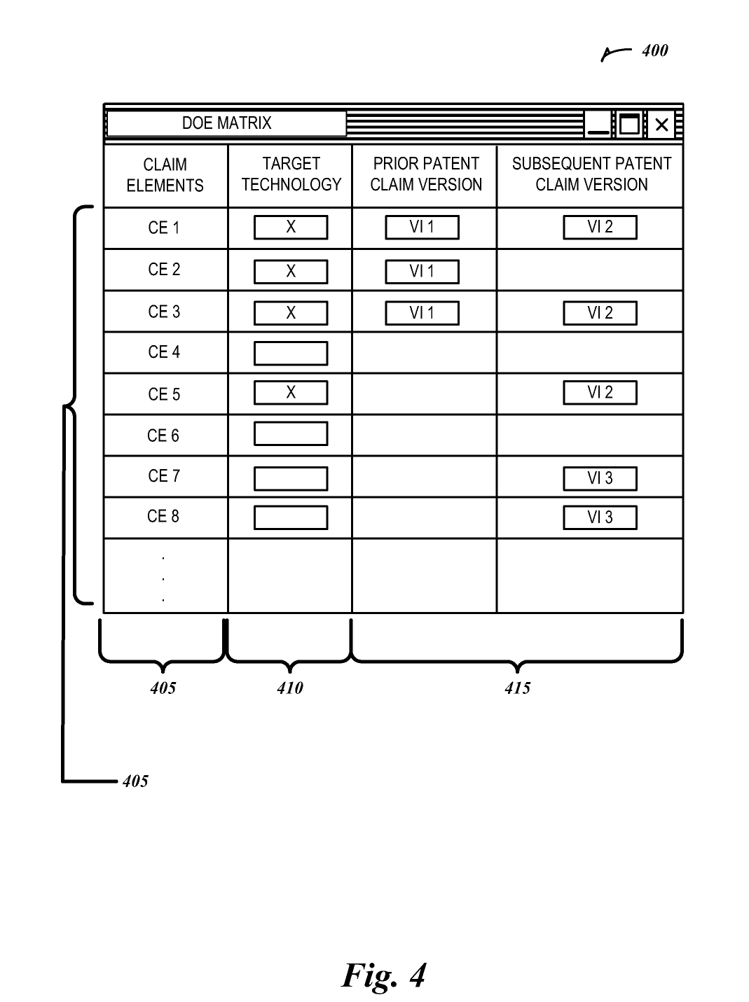

In some examples, the display module 110 can be configured to display the user interface 400 shown on FIG. 4. The user interface 400 can include a matrix. Rows of the matrix correspond to a patent claim version library set (PCV library set) 405. In some examples, the PCV library set 405 can include one or more claim elements (shown in FIG. 4 as cells in the “Claim Elements” column). In some examples, the PCV library set 405 is a subset of the claim element library discussed above. In some examples, the TT set and the PCV sets are subsets of the PCV library set 405. The user interface 400 can also include a target technology column 410 corresponding to the target technology. The user interface 400 can include an inclusion indicator at the intersection of a first row and the target technology column 410, where the first row corresponds to a claim element in the PVC library set 405 and the TT set. FIG. 4 illustrates the inclusion indicator as an “X” in the cells of target technology column 410. For example, as shown in FIG. 4, claim elements one, two, three and five, have corresponding inclusion indicators signifying the inclusion of those claim elements in the TT set and thus the target technology definition.

The user interface 400 can also include a plurality of patent claim version columns 415 where each patent claim version column in the plurality of patent claim version columns 415 can correspond to a patent claim version in the plurality of patent claim versions. In some examples, the patent claim version columns 415 can be arranged based on the chronological order of corresponding patent claim versions. That is, for a given patent claim version column, all columns to the left correspond either to earlier or to later versions of the patent claim, but not both. In some examples, the user interface 400 can include a visual indicator at the intersection of a second row and a patent claim version column from the plurality of patent claim version columns 415. The use of “first row” and “second row” are used here to separate the use of the inclusion indicator and the visual indicator, and not to mean that the “first row” could not be the “second row.” In some examples, the visual indicator can be one of three types.

In some examples, the visual indicator is a first type of visual indicator (shown in FIG. 4 as “VI 1”) if a claim element corresponding to the second row is in an intersection of the TT set and a PVC set corresponding to the patent claim version column, and the PVC set is a subset of the TT set. As discussed above, the patent claim corresponding to the PVC set would be literally infringed by the target technology under these circumstances. In some examples, the first type of visual indicator here is an alert (e.g., in red) as discussed above with respect to the user interface 300.

In some examples, the visual indicator is a second type of visual indicator if the claim element is in the intersection of the TT set and the PVC set, and the PVC set is not a subset of the TT set. Quickly referring to FIG. 2B, this intersection is represented in diagram 250 as the intersection 255. As discussed above, in this circumstance, the target technology does not literally infringe the corresponding patent claim. However, these claim elements represent an overlap in the patent claim and the target technology. As such, some attention by the user may be warranted. In some examples, the second type of visual indicator is in yellow or some other color (e.g., orange) representative to the user of caution. In some examples, the second type of visual indicator can be an icon, image, or the like, also representing caution to the user (such as a triangular “yield” icon).

In some examples, the visual indicator is a third type of visual indicator if the claim element is in the PVC set and not in the TT set. Again, like in the case where the second visual indicator is used, this case is one where the patent claim is not literally infringed by the target technology. Claim elements in which the third type of visual indicator can be used fall within the PCV set 215 after the intersection 255 is removed, as shown in diagram 250. In some examples, the third visual indicator is in green, or another color, representative of an acceptable condition to the user. In some examples, the third visual indicator can have the characteristics of the second visual indicator discussed above with respect to the user interface 300.

Using the user interface 400 can advantageously allow a user to quickly determine not only which version of the patent claim gives rise to the determination of non-infringement under the DOE, but also the specific claim elements. Moreover, by coding the visual indicators to elicit specific reactions in the user (such as alert, caution, or acceptable), a very fast impression can be conveyed to the user, thereby allowing the user's attention to be immediately drawn to the relevant claim elements.

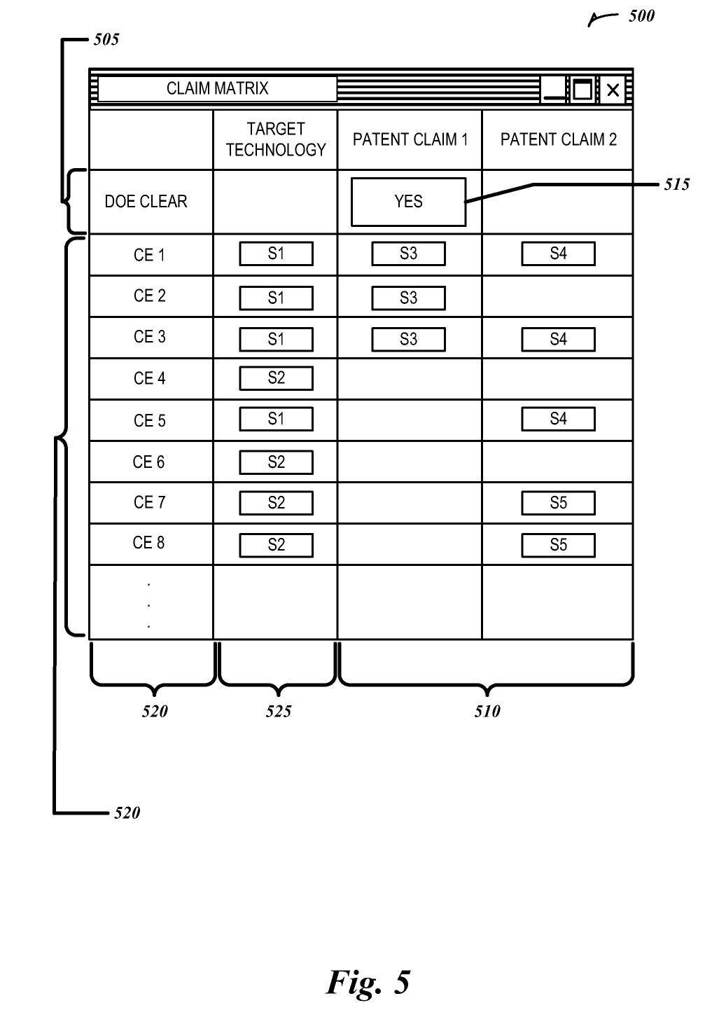

In some examples, the display module 110 can be configured to present the user, via a second user interface, a claim matrix (also known as a claim chart). An example of the second user interface is the user interface 500 shown in FIG. 5. Generally, a difference between the user interface 400 and the user interface 500 is the patent claims being analyzed. For example, the user interface 400 deals with versions of a single patent claim while the user interface 500 deals with different patent claims. In some examples, the user interface 500 includes a library set 520 including one or more claim elements. In some examples, the library set 520 is a subset of the library of claim elements discussed above. In some examples, the library set 520 includes the claim elements of the TT set and the claim elements of the different patents claims being analyzed. In some examples, the user interface 500 can include one or more patent claim visual components 510. Each patent claim visual component in the one or more patent claim visual components can correspond to a final patent claim version in a plurality of patent claims. In some examples, the final patent claim version is the version of the patent claim being analyzed for literal infringement by the target technology as opposed to the DOE analysis. Here, each patent claim visual component is a column in the claim matrix.

In some examples, each patent claim visual component includes a DOE visual component 505. In some examples, the DOE visual component 505 is only added to, or included in, patent claim visual components where the DOE indication demonstrates that the corresponding patent claim is not infringed by the target technology under the doctrine of equivalents. In some examples, the DOE visual component 505 displays a summary of the DOE indication 515. Thus, as a user performs general infringement analysis of several patent claims in the user interface 500, the user can also receive a quick indication that the target technology being analyzed not only does not literally infringe a patent claim, but that the target technology does not infringe the patent claim under the doctrine of equivalents. In some examples, the display module 110 can be configured to present the DOE user interface (e.g., user interface 300 or user interface 400) in response to the user selecting the DOE visual component 505. This allows the user to quickly “drill down” into the DOE infringement analysis.

As described above with respect to user interface 400 and the DOE analysis, user interface 500 can allow a user to quickly determine literal infringement (areas where the target technology overlaps with patent claims being analyzed) and areas covered by the patent claims that are not currently part of the target technology. A user can use this information to generally assess the patent landscape of the target technology as well as identify relevant patent claims to be considered. In support of literal infringement analysis, the system 100 can optionally include a memory module 120 and a marking module 125 to create and update a user interface, such as user interface 500.

In some examples, the memory module 120 can include a patent claim library including one or more patent claim elements. In some examples, the memory module 120 can include a TT set including one or more claim elements associated with the target technology. In some examples, the TT set is a non-empty subset of the patent claim library. In some examples, the memory module 120 can include a patent claim set corresponding to each of one or more patent claims where the patent claim set can include one or more claim elements associated with a corresponding patent claim. In some examples, the patent claim set is a non-empty subset of the patent claim library.

In some examples, the display module 110, in the context of general literal infringement analysis of the target technology against different patent claims, can optionally be communicatively coupled to the memory module 120 and also be configured to present a user interface including a matrix. Again, FIG. 5 provides an example user interface 500. In some examples, members of the patent claim library set 520 can correspond to rows of the matrix (CE rows), a target technology column (TT column) 525 can correspond to the target technology, and one or more patent claim visual components (PC columns) 510 can correspond with the one or more patent claims.

The system 100 can also optionally include a marking module 125. The marking module 125 can be configured to iterate through the CE rows and mark intersections between the CE rows and the TT column 525 or the PC columns 510.

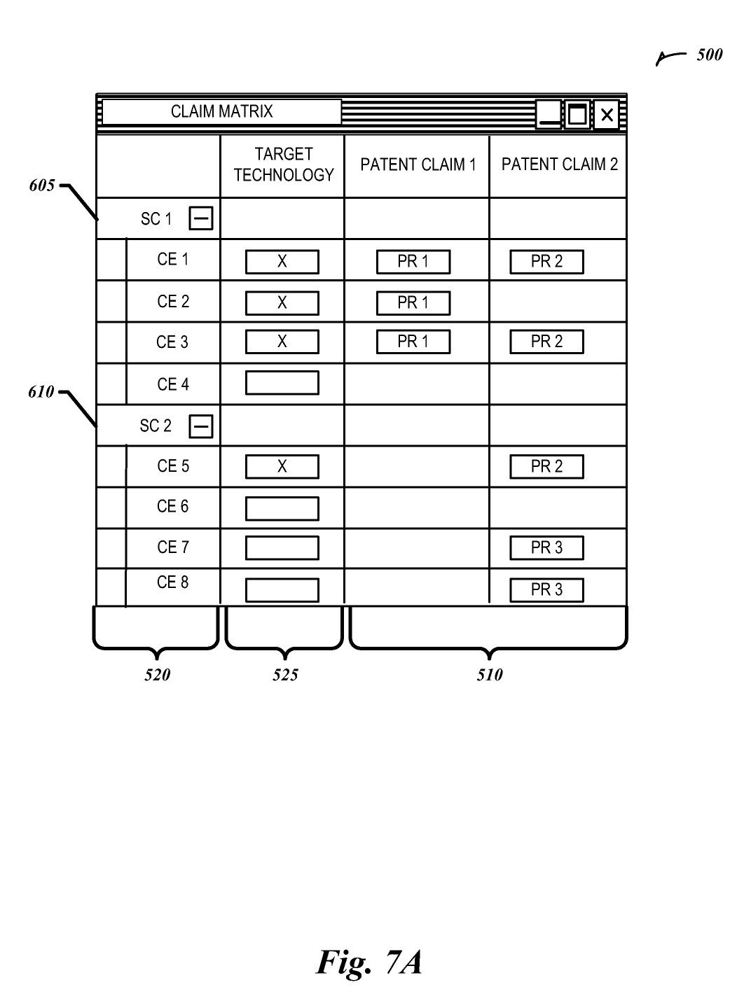

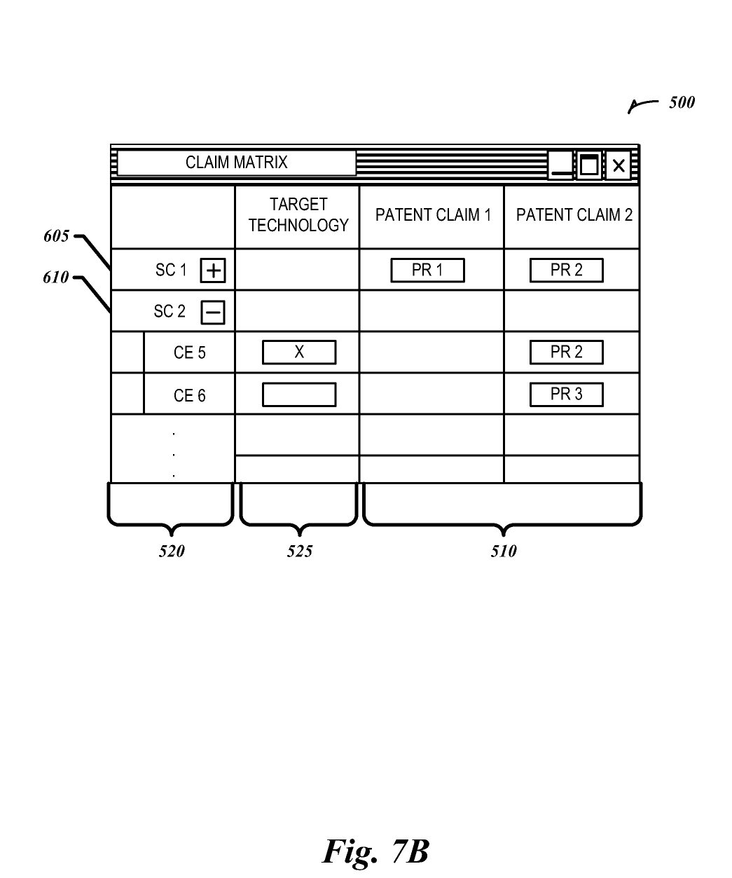

In some examples, for each CE row in the CE rows, the marking module 125 can be configured to mark each cell of the CE row intersecting the TT column with a first symbol if the claim element corresponding to the CE row is in the TT set. This is represented in the user interface 500 as the “S1” boxes in the TT column 525. The first symbol represents the inclusion of a particular claim element in the target technology definition. In some examples, the first symbol is interactive and allows the user to select it. In some examples, system 100 optionally includes a user input module 130 that is configured to receive user input at the first symbol. In some examples, the user input can include clicking on the first symbol, typing in the first symbol, or other user actions that can be received. In some examples the user input module 130 can be configured to remove the claim element corresponding to the CE row from the TT set. In some examples, the user input module 130 can then invoke the marking module 125 to reiterate through the CE rows and adjust the markings based on the new TT set. In some examples, the first symbol can be an “X” (as shown in FIGS. 7A and 7B).

In some examples, while iterating through the CE rows, the marking module 125 can be configured to mark each cell of the CE row intersecting the TT column 525 with a second symbol if the claim element corresponding to the CE row is not in the target technology set. This is represented in the user interface 500 as the “S2” boxes in the TT column 525. The second symbol marks the exclusion of a claim element from the target technology definition. In some examples, the second symbol is transparent (or even non-existent). In some examples, the second symbol is interactive (e.g., an un-checked checkbox). In some examples, the user input module 130 is configured to receive user input at the second symbol Like the first symbol, this input can comprise any input capable of being received by the user input module 130 (e.g., from a mouse, keyboard, touch screen, light-pen, remote control, etc.). In some examples, the user input module 130 can be configured to add the claim element to the target technology set. In some examples the user input module 130 can then be configured to invoke the marking module 125 to reiterate through the CE rows and adjust the markings based on the new TT set.

The first and second symbols provide the user with a quick and easy way to determine which claim elements are in the target technology set. Further, by adding the user input module, the user can quickly and conveniently change the target technology definition by adding or removing claim elements from the target technology definition. As these elements are added or removed, all of the claim matrix's markings can be updated. In this way a user can quickly “run” different target technology scenarios and immediately determine the result on the patent landscape being analyzed.

With respect to claim elements and the patent claims, the marking module 125 can be configured to mark each cell of the CE row intersecting a PC column with a third symbol (“S3” in user interface 500) if the claim element is in the target technology set and the patent claim set corresponding to the PC column 510, and the patent claim set is a subset of the target technology set. This circumstance is like that described above with reference to the diagram 200 and user interface 400 (e.g., the first type of visual indicator in FIG. 4). That is, in this circumstance, the target technology literally infringes the patent claim corresponding to the PC column 510. Thus, the third symbol is applied in user interface 500 for each claim element in the PC column 510. Like the first type of visual indicator described above, the third symbol can alert (in the same ways) the user that the claim element is in a patent claim, corresponding to the patent claim set, and that the patent claim is literally infringed by the target technology corresponding to the target technology set. In some examples, the third symbol can be a red box filling the cell.

In some examples, the marking module 125 can be configured to mark each cell of the CE row intersecting the PC column 510 with a fourth symbol (“S4” in user interface 500) if the claim element is in the TT set and the patent claim set, and the patent claim set is not a subset of the target technology set. This circumstance is like that described above with reference to the diagram 250 (e.g., claim elements in the intersection 255) and user interface 400 (e.g., the second type of visual indicator in FIG. 4). That is, in this circumstance, the target technology does not literally infringe the patent claim corresponding to the PC column 510, but the claim element is common to both the TT set and the PC set Like the second type of visual indicator described above, in some examples, the fourth symbol can caution, or alert, (in the same ways) a user that the claim element is in both a patent claim, corresponding to the patent claim set, and a target technology corresponding to the target technology set where the target technology does not literally infringe the patent claim. In some examples, the third symbol can be a yellow box filling the cell.

In some examples, the marking module 125 can be configured to mark each cell of the CE row intersecting a PC column 510 with a fifth symbol (“S5” in user interface 500) if the claim element is not in the target technology set, and the claim element is in the patent claim set. This circumstance is like that described above with reference to the diagram 250 (e.g., claim elements in the PC set 215 and not in the intersection 255) and user interface 400 (e.g., the third type of visual indicator in FIG. 4). That is, in this circumstance, the target technology does not literally infringe the patent claim corresponding to the PC column 510, nor is the claim element included in the target technology, but the claim element is in the PC set. Like the third type of visual indicator described above, the fifth symbol can indicate, or alert, (in the same ways) an acceptable condition to the user. The acceptable condition is that the claim element is in a patent claim, corresponding to the patent claim set, and not in a target technology corresponding to the target technology set. In some examples, the fifth symbol is a green box filling the cell.

Again, as described above with respect to the user interface 400 and the DOE analysis, providing the third, fourth, and fifth symbols graphically can allow the user to quickly ascertain the claim elements at issue, and those that can potentially be an issue, when analyzing the target technology vis-à-vis one or more patent claims. However, as the number of claim elements increases (for example, if a large number of patent claims are being analyzed), it may be difficult for the user to gain a quick impression of the complete landscape picture. One way in which the impact of a large number of patent claims can be mitigated is by grouping the patent claims for one or more purposes. One such grouping is known as a scope concept.

In some examples, a scope concept represents a collection of claim elements. In some examples, the representation can include a description that summarizes the content of the scope concept (e.g., summarizes the claim elements included within the scope concept). For example, if three claim elements respectively recited a “PC,” a “home computer,” and a “home based computing terminal,” they can be grouped in a scope concept with the possible description of “a personal computer.” In some examples, scope concepts can be used to represent equivalent claim elements, such as in the personal computer example. In some examples, the scope concept can be used in place of the claim elements to perform either a literal, or DOE, infringement analysis. In these examples, the scope concept can be represented by a scope concept set (SC set) that includes one or more claim elements.

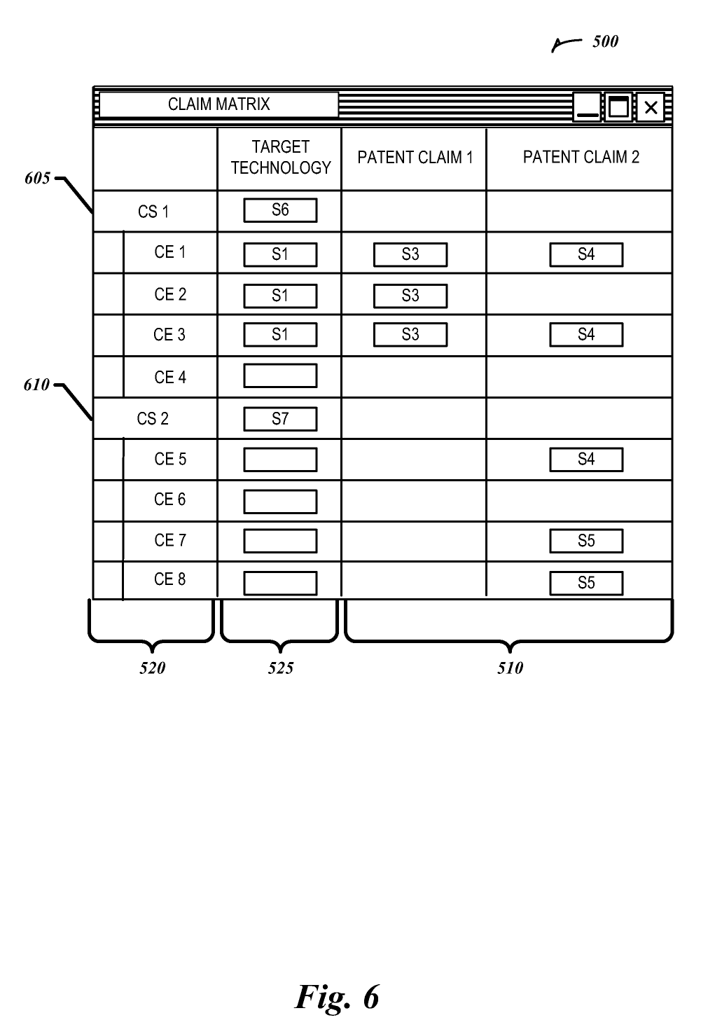

Scope concepts can be integrated into the user interface (e.g., user interface 500), by adding one or more scope concept rows (SC rows) (e.g., SC row 605 and SC row 610) to the matrix as shown in FIG. 6. Visually, the claim elements in the scope concept set can be displayed in a child position, or otherwise denote the inclusion of the CE rows (or other visual components representing claim elements).

In some examples, the marking module 125 can be configured to iterate through SC rows of the matrix. For each SC row (e.g., SC row 605 and SC row 610), the marking module 125 can be configured to mark each cell of the SC row 605 intersecting the TT column 525 with a sixth symbol if a scope concept set corresponding to the SC row 605 is not-empty and is a subset of the target technology set. The sixth symbol is similar to the first symbol described above with respect to individual claim elements. However, the sixth symbol represents all of the claim elements in the scope concept set. In some examples, the sixth symbol varies depending upon whether all of the child claim elements are in the TT set or only some are. In some examples, the sixth symbol is the same if even one child claim element is in the TT set. In some examples, the sixth symbol is interactive. In some examples, the sixth symbol is represented like, or interactive in, the same way described above with respect to the first symbol. In some examples, the user input module 130 is configured to receive user input at the sixth symbol and remove claim elements from the target technology set in the intersection of the target technology set and the scope concept set. That is, all of the scope concept's child claim elements are removed from the TT set. The user input module 130 can be configured to then invoke the marking module 125 to reiterate through the CE rows and SC rows 605, 610. In this way, the user can remove a group of claim elements from the target technology and immediately observe the resultant infringement analysis of system 100.

In some examples, the marking module 125 can be configured to mark each cell of the SC row 610 intersecting the TT column 525 with a seventh symbol not if the cell is not already marked by the sixth symbol. The seventh symbol is a scope concept analogue to the second symbol for claim elements, much like the sixth symbol is to the first symbol. In some examples, the seventh symbol is interactive. In some examples, the user input module 130 is configured to receive user input at the seventh symbol and add claim elements from the TT set in the intersection of the target technology set and the scope concept set. The user input module 130 can be configured to then invoke the marking module 125 to reiterate through the CE rows and SC rows 605, 610 to update the markings (e.g., the first through seventh symbols). In this way, the user can remove a group of claim elements to the target technology and immediately observe the resultant infringement analysis of system 100.

Using scope concepts in the user interface 500 to manage claim elements as described above can provide the user with convenient options to add and remove various claim elements to the target technology and observe the infringement analysis results performed by the system 100. However, as mentioned above, the sheer number of claim elements may overwhelm the user or may simply be burdensome to view. Because the scope concept and associated claim elements can be represented in a parent-child relationship, a convenient solution can be to allow the user to collapse the child claim elements (e.g., hide the CE rows) and leave a scope concept representation (e.g., SC row 605) in its place. However, in order to also convey the same information as to relevance of patent claims to the target technology, the scope concept representation can be changed to summarize the information of the representations of the claim elements (e.g., CE rows). FIGS. 7A and 7B respectively illustrate the expanded form and the collapsed form of the scope concept representation as a user interface control.

To facilitate full use of scope concepts with respect to the user interface 500, the system 100 can optionally include a priority module 115. The priority module 115 can be used to evaluate the claim elements to determine how the SC row 605 (or other scope concept visual component) is to visually represent the claim elements. In some examples, the priority module 115 can be configured to determine a priority value for each of one or more claim elements associated with a scope concept. In some examples, the memory module 120 can be configured to include a representation of each of the one or more claim elements (e.g., CE rows or other user interface component), an un-collapsed representation of the scope concept (e.g., SC row 605 as shown in FIG. 7A, or other user interface component), and a collapsed representation of the scope concept (e.g., SC row 605 as shown in FIG. 7B) including a summary of the claim elements (e.g., “PR 1” in FIG. 7B in SC row 605). In some examples, the display module 110 can be configured, via a user interface (e.g., user interface 500), to display the un-collapsed representation of the scope concept (e.g., SC row 605 as shown in FIG. 7A) and the representation of each of the one or more claim elements (e.g., CE rows). The display module 110 can also be configured to display the representation of each of the one or more claim elements (e.g., CE rows) in response to user input (e.g., using the user input module 130) on the un-collapsed representation of the scope concept (e.g., SC row 605 as shown in FIG. 7A). The display module 110 can further be configured to replace the un-collapsed representation of the scope concept (e.g., SC row 605 as shown in FIG. 7A) with the collapsed representation of the scope concept (e.g., SC row 605 as shown in FIG. 7B). In some examples, the display module 110 is configured to replace the collapsed representation of the scope concept (e.g., SC row 605 as shown in FIG. 7B) with the un-collapsed representation of the scope concept (e.g., SC row 605 as shown in FIG. 7A) in response to user input on the collapsed representation of the scope concept (e.g., SC row 605 as shown in FIG. 7B) and un-hide the representation of each of the one or more claim elements (e.g., CE rows).

In order to determine what the summary of the claim elements should be, the claim elements can be prioritized. In some examples, the priority values of the claim elements can be assigned by the priority module 115. In some examples, the priority value is represented as a numerical value. Other priority values can be used such that different priority values can be compared. In some examples, the priority module 115 can be configured to determine the priority value for each of the one or more claim elements by assigning a highest priority value to claim elements corresponding to a patent claim literally infringed by a target technology (shown in FIGS. 7A and 7B as “PR 1”), assigning a middle priority value to claim elements corresponding to the target technology and a second patent claim not literally infringed by the target technology (shown in FIGS. 7A and 7B as “PR 2”), assigning a lower middle priority value to claim elements corresponding to the second patent claim and not the target technology (shown in FIGS. 7A and 7B as “PR 3”), and assigning the lowest priority value to other claim elements (shown in FIGS. 7A and 7B as empty cells under the PC columns 510).

Because a purpose of the claim elements summary is to provide similar information to the user after the claim element representations are hidden, a representation of the claim element can be similar to those described above with respect to FIGS. 5 and 6. In some examples, the highest priority coincides with the third symbol, or the first visual indicator; the middle priority coincides with the fourth symbol, or the second visual indicator; and the lower middle priority coincides with the fifth symbol, or the third visual indicator, as described above. The lowest priority would generally then coincide to cells where a claim element is not represented in a patent claim. In some examples, a representation of a claim element is red if the claim element is assigned the highest priority value, yellow if the claim element is assigned the middle priority value, green if the claim element is assigned the lower middle priority value, and transparent if the claim element is assigned the lowest priority value.

In some examples, the summary of the claim elements can include a representation of a claim element corresponding to a claim element assigned the highest priority. That is, the highest priority claim element can be considered to be the most relevant to the user. Thus, if the highest priority is literal infringement, the summary can indicate that the scope concept includes a highest priority claim element simply by incorporating the representation of the claim element. Such an example is provided in FIG. 7B with respect to the cell at the intersection of the representation of the SC row 605 and “Patent claim 1.” The intersection of “Patent claim 2” illustrates a lower priority claim element representation with respect because the highest priority of “Patent claim 2,” as observed in FIG. 7A, is “PR 2.”

In some examples, a more complete summary can be achieved by combining the representations of the claim elements in the collapsed representation of the scope concept (e.g., SC row 605 as shown in FIG. 7B). In some examples, the summary of the claim elements includes a proportional representation of claim elements based on the prevalence of assigned priority values in corresponding claim elements. This may best be explained by the example of “Patent claim 2” in FIG. 7A. With respect to the SC row 610, “Patent claim 2” has one “PR 2” claim element and two “PR 3” claim elements, for a total of three claim elements with assigned priorities above the lowest priority. Visually, the summary could be divided into thirds, with one third being yellow (for the “PR 2” value) and two thirds green (for the “PR 3” values). Thus, a visual combination of the constituent representations of the claim elements can be used.

By updating the visual component corresponding to scope concepts when the child claim elements are hidden (i.e., when the scope concept is collapsed) to summarize the infringement information of those child elements, system 100 can continue to provide ready information to the user about the infringement analysis while still allowing the user to manage a large number of claim elements. This flexibility allows the user to easily and efficiently manage larger portfolios of patent claims and thus provide a better infringement analysis of the target technology.

A further benefit that system 100 can provide to the user is in regard to the relevance of patent claims with respect to the infringement analysis of the target technology. As suggested above, a feature of system 100's output is to allow a user to quickly determine relevant patent claims. However, system 100 can also automatically order the patent claims by degrees of infringement in order to place the most likely relevant patent claims closer to the target technology. This can provide the benefit of reducing viewing actions (e.g., scrolling) while the user attempts to locate which patent claims upon which to focus.

To facilitate the ordering of the patent claims, for example in the patent matrix, system 100 can optionally include a comparing module 135 configured to compare a target technology with a plurality of patent claims in order to assign a degree of literal infringement to each of the patent claims in the plurality of patent claims. The display module 110 can be configured to present a user interface (e.g., user interface 500), including a visual representation of each of the plurality of patent claims (e.g., PC columns 510), and order the visual representation of each of the plurality of patent claims based on the assigned degree of literal infringement. In some examples the target technology includes a set of claim elements (TT elements), and each of the patent claims includes a set of claim elements (PC elements). In some examples, the degree of literal infringement for a patent claim is assigned to the patent claim based on the number of PC elements not in the TT elements (the PC elements corresponding to the patent claim). This is the same as the PC elements set 215 of FIG. 2B without the intersection 255. Thus, the more claim elements that would need to be added to the target technology to literally infringe the patent claim, the lower the assigned degree of infringement.

In some examples, the degree of literal infringement for the patent claim is further based on the number of PC elements common with the TT elements where the PC elements are not a subset of the TT elements. This is the same as the intersection 255 of FIG. 2B. Thus, even if two patent claims have the same number of elements not in the TT elements, the patent claim with more claim elements in the TT elements set has a higher assigned degree of infringement. In some examples, the highest degree of literal infringement represents literal infringement of the patent claim by the target technology. This is represented in FIG. 2A, where PC elements 215 are a subset of the TT elements 210.

In some examples, the display module 110 is configured to order the visual representation of each of the plurality of patent claims (e.g., PC columns 510) by placing a first visual representation of a first patent claim (e.g., “Patent claim 1”) closer to the visual representation of the target technology (e.g., TT column 525) than a second visual representation of a second patent claim (e.g., “Patent claim 2”), where the first patent claim has a higher degree of literal infringement than the second patent claim. Thus, the more the target technology literally infringes a patent claim, the closer the patent claim is placed to the visual representation of the target technology. In this way, the most likely relevant patent claims, from an infringement analysis perspective, are less likely to be missed by the user.

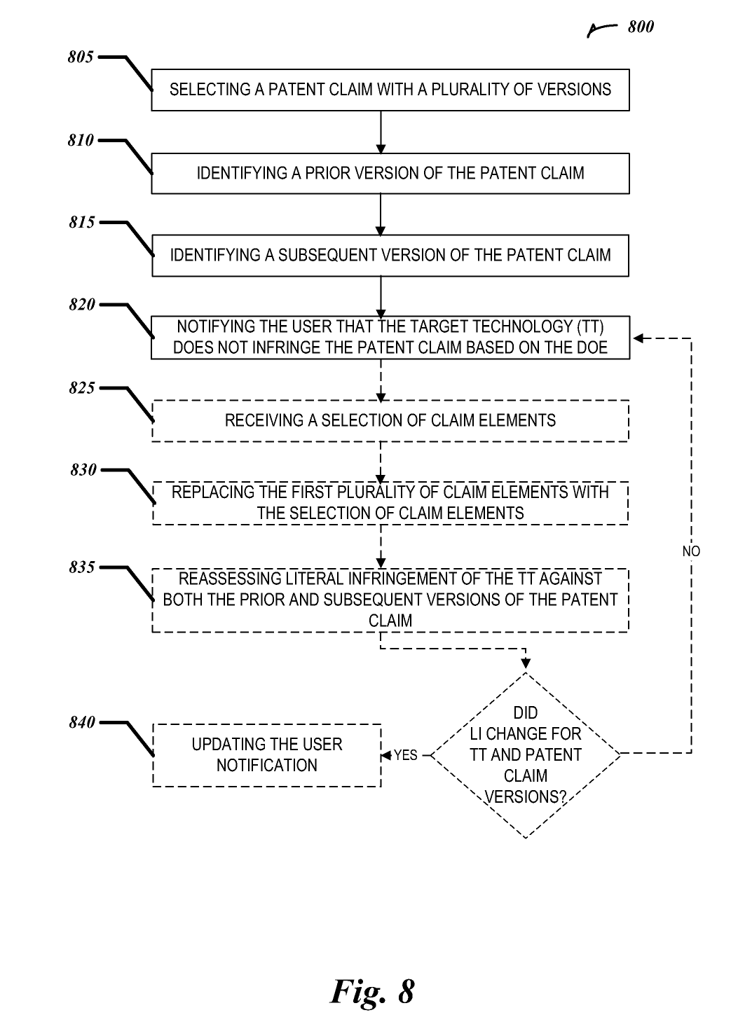

FIGS. 8-11 illustrate various methods (800-1100), according to embodiments of the present disclosure. Methods 800-1100 can be performed using any combination of the components discussed above, including those of FIG. 1 and those of FIGS. 3-7B, or methods 800-1100 can be performed using other combinations of hardware including temporarily configured hardware (e.g., by software). As such, the descriptions of methods 800-1100 may reference specific components from FIGS. 1 and 3-7B for descriptive purposes, but methods 800-1100 are not so limited.

FIG. 8 illustrates an example method 800 to determine non-literal non-infringement, according to one embodiment. In some examples, the method 800 can include operations such as selecting a patent claim 805, identifying a prior version 810, identifying a subsequent version 815, and notifying a user 820. In some examples, the method 800 can optionally include operations such as receiving a selection of claim elements 825, replacing a first set of claim elements with the selected set 830, reassessing literal infringement 835, and possibly updating the user notification 840.

At operation 805, a patent claim with a plurality of versions is selected. That is, the selected patent claim has changed at least once via amendment before it is selected. Thus, it has, at least an original, as-filed, version, and a subsequent version following an amendment. In some examples, the patent claim is manually selected. In some examples, the patent claim is automatically selected based on a determination that the patent claim does not literally infringe a target technology. In some examples, literal infringement is determined by associating a set of claim elements with the target technology, and determining if the claim elements of the patent claim constitute a subset of the set of claim elements in the target technology. If they are not a subset, then the target technology does not literally infringe the patent claim.

In some examples, the target technology can include a first plurality of claim elements, the prior version of the patent claim can include a second plurality of claim elements, and the subsequent version of the patent claim can include a third plurality of claim elements. As described above, claim elements provide a convenient way to determine literal infringement of the target technology vis-à-vis patent claims, and thus also the ability to determine non-infringement under the DOE.

At operation 810, a prior version of the patent claim is identified, from the plurality of versions, that a target technology does literally infringe. In some examples, identifying the prior version of the patent claim can include determining that the second plurality of claim elements is a subset of the first plurality of claim elements (i.e., the target technology literally infringes the prior version of the patent claim). In some examples, the prior version of the patent claim precedes, in time, at least one other version of the patent claim in the plurality of patent claim versions.

At operation 815, a subsequent version of the patent claim is identified, from the plurality of patent claims, that the target technology does not literally infringe. The subsequent version of the patent claim is also identified based on having at least one claim amendment in comparison with the prior version of the patent claim. In some examples, the inclusion of the claim amendment can be determined automatically by comparing the text of the prior and subsequent versions of the patent claim. In some examples, the inclusion of the claim amendment can be determined automatically by searching for specific events in the prosecution history of the patent claim. In some examples, identifying the subsequent version of the patent claim can include determining that the third plurality of claim elements (e.g., from the subsequent version as opposed to the prior version which may include the second plurality of claim elements) is not a subset of the first plurality of claim elements (e.g., from the target technology). That is, the target technology does not literally infringe the subsequent version of the patent claim.

At operation 820, a user is notified, based on identifying the subsequent version of the patent claim, that the target technology does not infringe the patent claim based on the DOE. In some examples, the notification can be displaying an indicator to the user via a user interface. Example user interfaces can include user interfaces 300, 400, or 500. In some examples, the indicator to the user can include displaying a chronology of the patent claim, such as user interface 300. The indicator can also include a first visual indicator (VI 1 in FIG. 3) showing the prior version of the patent claim and a second visual indicator (VI 2 in FIG. 3) showing the subsequent version of the patent claim. This can provide a user with a quick assessment of non-infringement of the patent claim by the target technology, as well as which specific versions of the patent claim led to this conclusion.

In some examples, displaying the chronology can include displaying a matrix with target technology components occupying one or more rows and the plurality of versions of the patent claim occupying two or more columns in chronological order (as shown in user interface 400, for example). Here, the first visual indicator is placed at the intersection of a target technology component and the prior version of the patent claim, and the second visual indicator is placed at the intersection of the target technology component and the subsequent patent claim. In some examples, the first visual indicator can be in red, and the second visual indictor can be in green. The colors red and green instigate particular responses in people, and so noting the prior version in red brings the user's attention to that version of the patent claim, while noting the current version of the patent claim in green allows immediately indicates to the user that the target technology does not infringe that version of the patent claim. In some examples, other colors or visual symbols (e.g., a stop sign image and a “GO” sign) can be used. Here, the user not only can identify the version of the patent claim that gave rise to the non-infringement determination under the DOE, but the user can readily see what subject matter was forfeited by the patent claim's owner during prosecution.

At operation 825, method 800 can optionally include receipt of a selection of claim elements. In some examples, the selection of claim elements is provided by a user.

At operation 830, method 800 can optionally include replacement of the first plurality of claim elements (i.e., the claim elements that are currently part of the target technology) with the selection of claim elements received at operation 825.

At operation 835, method 800 can optionally include a reassessment of literal infringement of the target technology against the prior version of the patent claim and the subsequent version of the patent claim based on the replaced first plurality of claim elements, the second plurality of claim elements, and the third plurality of claim elements. Because the original determination of non-infringement under the DOE used the claim elements previously associated with the target technology (i.e., the first plurality of claim elements), a change in those claim elements can yield a different non-infringement determination. Thus, reassessment allows the non-infringement determination to remain current while allowing a user to flexibly manipulate the target technology definition to, for example, quickly assess various manufacturing scenarios against the patent landscape.

At operation 840, method 800 can optionally include updating the notification to the user if the reassessment of operation 835 changes the literal infringement (LI) of the target technology to either the prior version of the patent claim or the subsequent version of the patent claim. In some examples, the updating is done in real-time. Again, providing an effective visual tool for a user to quickly assess the impact of the non-infringement analysis allows the user to efficiently incorporate the analysis into their decision making process (e.g., business decisions, legal decisions, etc.).

In some examples, the various operations of method 800 can be expressed as follows. They can be implemented in machine instructions that cause the machine to determine a patent claim that a target technology does not literally infringe, determine a prior version of the patent claim that the target technology does literally infringe, and present a user interface indicating that the target technology does not infringe the patent claim based on the DOE.

In some examples, the presentation instructions can optionally instruct the machine to present a user interface (e.g., user interface 400) that includes a representation of a first plurality of claim elements included in the patent claim, a second plurality of claim elements included in the prior version of the patent claim, and a third plurality of claim elements included in the target technology. In some examples, a first visual indicator (e.g., VI 1 from FIG. 4) can represent the second plurality of claim elements, a second visual indicator (e.g., VI 2 from FIG. 4) represents the first plurality of claim elements that are common with the third plurality of claim elements, and a third visual indicator (e.g., VI 3 from FIG. 4) represents the first plurality of claim elements that are not common with the third plurality of claim elements.

In some examples, the instructions can optionally cause the machine to update the target technology's claim elements in response to user input, determine that the target technology does not literally infringe the patent claim based on the updated target technology claim elements, determine that the target technology does literally infringe the prior version of the patent claim based on the updated target technology claim elements, and re-present the user interface.

In some examples, the instructions can optionally cause the machine to present a visual claim element in a claim chart (e.g., DOE visual component 505). In some examples, the visual claim element corresponds to the patent claim in the claim chart (e.g., the summary of the DOE indication 515).

In some examples, the presentation instructions can optionally cause the machine to present the user interface in response to receipt of user input (e.g., clicking on the summary of the DOE indication 515) on the visual claim element.

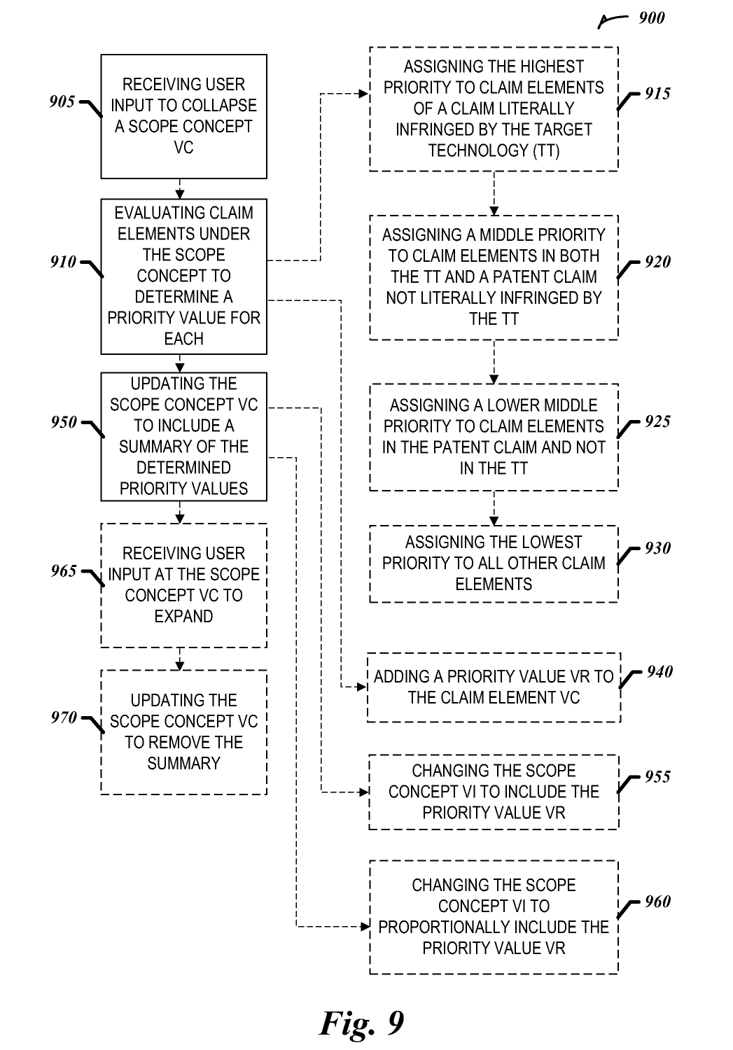

FIG. 9 illustrates an example method 900 of updating a scope concept visual component with a summary of the claim elements associated with the scope concept, according to one embodiment.

At operation 905, the method 900 begins with, for example, the user input module 130 receiving user input directed to a scope concept visual component (e.g., SC row 605 or Sc row 610). In some examples, the user input can collapse one or more claim element visual components (e.g., CE rows as shown in FIG. 7A) displayed as children to the scope concept visual component.

At operation 910, claim elements corresponding to the one or more claim element visual components can be evaluated, by the priority module 115 for example, to determine a priority value for each claim element.

At operation 915, operation 910 can optionally include assigning (e.g., by the priority module 115) the highest priority value to claim elements corresponding to a patent claim literally infringed by a target technology.

At operation 920, operation 910 can optionally include assigning (e.g., by the priority module 115) a middle priority value to claim elements corresponding to the target technology and a second patent claim not literally infringed by the target technology.

At operation 925, operation 910 can optionally include assigning (e.g., by the priority module 115) a lower middle priority value to claim elements corresponding to the second patent claim and not the target technology.

At operation 930, operation 910 can optionally include assigning (e.g., by the priority module 115) the lowest priority value to other claim elements. These elements are not in the patents claims being analyzed or the target technology and so are usually left unmarked in order to reduce clutter for the user.

In some examples, the visual representation (e.g., by the display module 110) of the priority value can be in red for the highest priority value, yellow for the middle priority value, green for the lower middle priority value, and transparent for the lowest priority value.

At operation 940, operation 910 can optionally include adding (e.g., by the display module 110) a visual representation of a priority value (e.g., PR components in FIG. 7A) for a corresponding claim element to the corresponding claim element visual component.

At operation 950, the scope concept visual component can be updated (e.g., by the display module 110) to include a summary of the claim elements based on the determined priority value for each claim element.

At operation 955, operation 950 can optionally include changing (e.g., by the display module 110) the scope concept visual component to include the visual representation of the priority value for a highest priority value. An example of this can be seen between FIGS. 7A and 7B with respect to scope concept visual component SC row 605. Note how, for example, patent claim 1's “PR 1” (a visual representation of a priority one value) from FIG. 7A is moved into SC row 605 with respect to patent claim 1.

At operation 960, operation 950 can optionally include changing (e.g., by the display module 110) the scope concept visual component to include the visual representation of the priority value for each claim element in proportion to a distribution of priority values in the claim elements. For example, if the visual representations of priorities one, two and three are respectively red, yellow, and green boxes, the scope concept visual component can include red, yellow, and green, with the visible area used by each color tied to the number of claim elements under the scope concept having each of the associated priorities. Thus, if two claim elements are associated with a red priority, one with a yellow priority, and one with a green priority, then the area of the red in the scope concept visual element can be equal to the combined yellow and green areas.

At operation 965, method 900 can optionally include receiving (e.g., by the user input module 130) user input at the scope concept visual component to expand the claim element visual components.

At operation 970, method 900 can optionally include updating (e.g., by the display module 110) the scope concept visual component to remove the summary of the claim elements.

By summarizing the claim elements associated with a scope concept, in the scope concept visual component, user can reduce clutter by collapsing the scope concept while still having ready access to the most pertinent information contain within the claim elements.

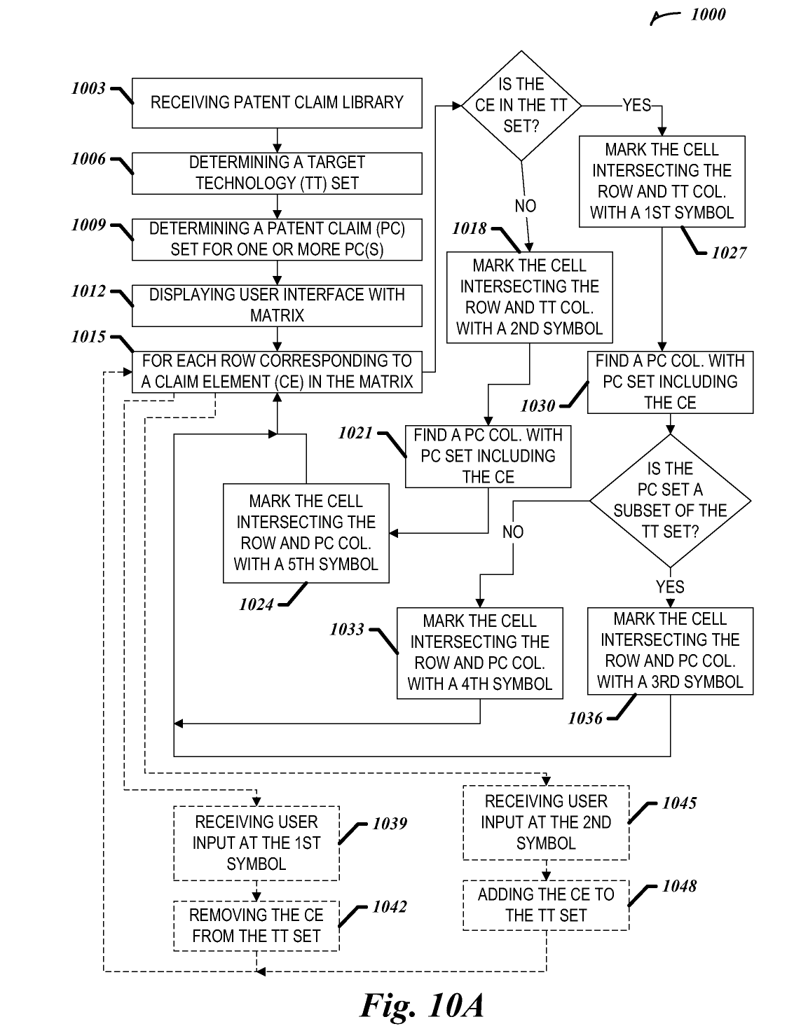

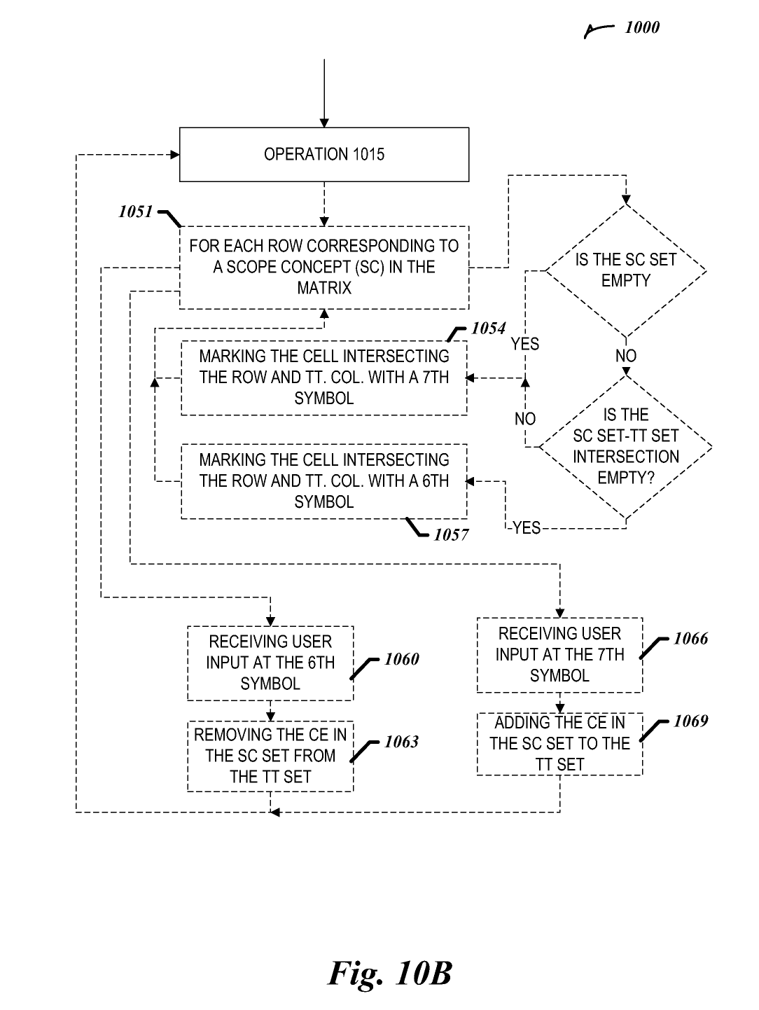

FIG. 10A illustrates an example method 1000 to automatically update a claim matrix to allow quick identification of literal infringement, while FIG. 10B includes another view of method 1000 with optional additional operations. FIGS. 5 and 6 include an example user interface 500 of a claim matrix that can be an example result of the operations of method 1000. In some examples, the method 1000 can include operations such as receiving a patent claim library 1003, determining a target technology set 1006, determining a patent claim set 1009, displaying a user interface 1012, and iterating through each row, of a claim matrix, corresponding to claim elements to mark cells intersecting the row and columns associated with either the target technology or a patent claim 1015-1036.

At operation 1003, a patent claim library can be received (e.g., into the memory module 120 or by the marking module 125). In some examples, the patent claim library can include one or more patent claim elements.

At operation 1006, a target technology set can be determined (e.g., by the memory module 120). The target technology set can include one or more claim elements associated with the target technology and the target technology set is a non-empty subset of the patent claim library.

At operation 1009, a patent claim set can be determined (e.g., by the memory module 120) for each of one or more patent claims. The patent claim set can include one or more claim elements associated with a corresponding patent claim and the patent claim set is a non-empty subset of the patent claim library. That is, each patent claim has a corresponding patent claim set including the claim elements of the patent claim.

At operation 1012, a user interface can be displayed (e.g., by the display module 110). In some examples the user interface can include a matrix. Within the matrix, members of the patent claim library correspond to rows of the matrix (CE rows), a target technology (TT) column corresponds with the target technology, and patent claim (PC) columns correspond with the one or more patent claims. FIG. 5 illustrates an example user interface 500 exhibiting these properties.

At operation 1015, the CE rows can be iterated through (or over) by, for example, the marking module 125. The iteration can proceed such that, for each CE row in the CE rows, select the next CE row as the (current) CE row until all CE rows have been processed. For the purposes of the remaining operations, each CE row is associated with a unique claim element. Accordingly, action on the claim element can affect the corresponding CE row and vice versa.

At operation 1018, each cell of the CE row intersecting the TT column can be marked (e.g., by the marking module 125) with a second symbol if the claim element corresponding to the CE row is not in the target technology set. FIG. 5 illustrates an example result where the S2 components in the target technology visual component (e.g., TT column 525) correspond to the second symbol. In some examples the second symbol can be an unchecked checkbox user interface component. In some examples, the second symbol can be transparent (e.g., a blank cell).

At operation 1021, a PC column is sought that includes the claim element. If no such PC column is found, method 1000 can continue on to operation 1015 to processes other CE rows.

At operation 1024, each cell of the CE row intersecting the PC column can be marked (e.g., by the marking module 125) with a fifth symbol if the claim element is not in the target technology set, and the claim element is in the patent claim set. FIG. 5 illustrates the fifth symbol marking as S5 components. After the fifth symbols are placed, method 1000 can continue on to operation 1015 to processes other CE rows. In some examples, the fifth symbol is a green box filling the cell. In some examples, the fifth symbol alerts the user that the claim element is in the patent claim, corresponding to the patent claim set, and not in the target technology corresponding to the target technology set.

At operation 1027, each cell of the CE row intersecting the TT column can be marked (e.g., by the marking module 125) with a first symbol if the claim element corresponding to the CE row is in the target technology set. FIG. 5 gives an example illustration of the first symbol markings as S1 components. In some examples, the first symbol can be a checked checkbox user interface component. In some examples, the first symbol can be a visual check, such as an ‘X’ to indicate the claim elements inclusion in the target technology.

At operation 1030, like operation 1021, a PC column is sought that includes the claim element. If no such PC column is found, method 1000 can continue on to operation 1015 to processes other CE rows.

At operation 1033, each cell of the CE row intersecting the PC column can be marked (e.g., by the marking module 125) with a fourth symbol if the claim element is in the target technology set and the patent claim set, and the patent claim set is not a subset of the target technology set. FIG. 5 gives an example illustration of the fourth symbol markings as S4 components. After the fourth symbols are placed, method 1000 can continue on to operation 1015 to processes other CE rows. In some examples, the fourth symbol alerts the user that the claim element is in both the patent claim and the target technology and that the target technology does not literally infringe the patent claim. In some examples, the fourth symbol is a yellow box filling the cell.

At operation 1036, each cell of the CE row intersecting a PC column can be marked (e.g., by the marking module 125) with a third symbol if the claim element is in the target technology set and the patent claim set corresponding to the PC column, and the patent claim set is a subset of the target technology set. FIG. 5 gives an example illustration of the third symbol markings as S3 components. After the third symbols are placed, method 1000 can continue on to operation 1015 to processes other CE rows. In some examples, the third symbol alerts the user that the claim element is in the patent claim, corresponding to the patent claim set, that is literally infringed by the target technology. In some examples, the third symbol is a red box filling the cell.

At operation 1039, method 1000 can optionally include receiving user input (e.g., by the user input module 130) at the first symbol. For example, the user may have clicked on an S1 component as illustrated in FIG. 5. Other input types are also contemplated, including keyboard or touch-screen inputs.

At operation 1042, method 1000 can optionally include removing (e.g., by the memory module 120) the claim element associated with the first symbol of operation 1039 from the target technology set. Method 1000 can continue on to operation 1015 to reiterate over the CE rows with the new target technology set. In this way, users can easily modify the target technology and immediately see how removing a claim element affects the infringement analysis.

At operation 1045, method 1000 can optionally include receiving user input (e.g., by the user input module 130) at the second symbol. Like the user input received at operation 1039, on, for example an S2 component of FIG. 5, various types of user input are contemplated.

At operation 1048, method 1000 can optionally include adding (e.g., by the memory module 120) the claim element to the target technology set. Method 1000 can continue on to operation 1015 to reiterate over the CE rows with the new target technology set. In this way, users can easily modify the target technology and immediately see how adding a claim element affects the infringement analysis.

As previously stated, FIG. 10B illustrates additional, optional operations for method 1000.

At operation 1051, method 1000 can optionally include matrix rows corresponding to a scope concept (SC rows) that can be iterated through (or over). The iteration (e.g., by the marking module 125) proceeding such that, for each SC row in the SC rows, select the next SC row as the (current) SC row until all SC rows have been processed. For the purposes of the remaining operations, each SC row is associated with a unique scope concept. Accordingly, action on the scope concept can affect the corresponding SC row and vice versa.

At operation 1054, method 1000 can optionally include marking (e.g., by the marking module 125) each cell of the SC row intersecting the TT column with a seventh symbol if the scope concept set is empty or if the scope concept set has an empty intersection with the target technology set. FIG. 6 gives an example illustration of the seventh symbol markings as the S7 component corresponding to SC row 610. In some examples, the seventh symbol can be an un-checked checkbox user interface component.

At operation 1057, method 1000 can optionally include marking (e.g., by the marking module 125) each cell of the SC row intersecting the TT column with a sixth symbol if the scope concept set is not-empty, and the intersection between the scope concept set and the target technology set is not empty. FIG. 6 gives an example illustration of the sixth symbol markings as the S6 component corresponding to SC row 605. In some examples, the sixth symbol can be a checked checkbox user interface component. In some examples, the sixth symbol can be a visual check, such as an ‘X’ to indicate the inclusion of some claim elements associated with the scope concept in the target technology.

At operation 1060, method 1000 can optionally include receiving user input (e.g., by the user input module 130) at the sixth symbol. In some examples this can be a mouse click. However, in some examples, any user interaction with the sixth symbol can be received as input.

At operation 1063, method 1000 can optionally include removing (e.g., by the memory module 120) claim elements from the target technology set in the intersection of the target technology set and the scope concept set corresponding to the sixth symbol of operation 1060. Method 1000 can then proceed to operation 1015 to reiterate the CE rows, and proceed to operation 1051 to reiterate of the SC rows, in order to update the symbol markings based on the new target technology set. In this way, a user can quickly remove all of the claim elements of a scope concept from the target technology and observe the impact on the infringement analysis.

At operation 1066, method 1000 can optionally include receiving user input (e.g., by the user input module 130) at the seventh symbol. In some examples, this can be a mouse click. However, in some examples, any user interaction with the seventh symbol can be received as input

At operation 1069, method 1000 can optionally include adding (e.g., by the memory module 120) the claim elements from the scope concept set, corresponding to the seventh symbol of operation 1066, to the target technology set. Method 1000 can then proceed to operation 1015 to reiterate of the CE rows, and proceed to operation 1051 to reiterate of the SC rows, in order to update the symbol markings based on the new target technology set. In this way, a user can quickly add all of the claim elements of a scope concept to the target technology and observe the impact on the infringement analysis.

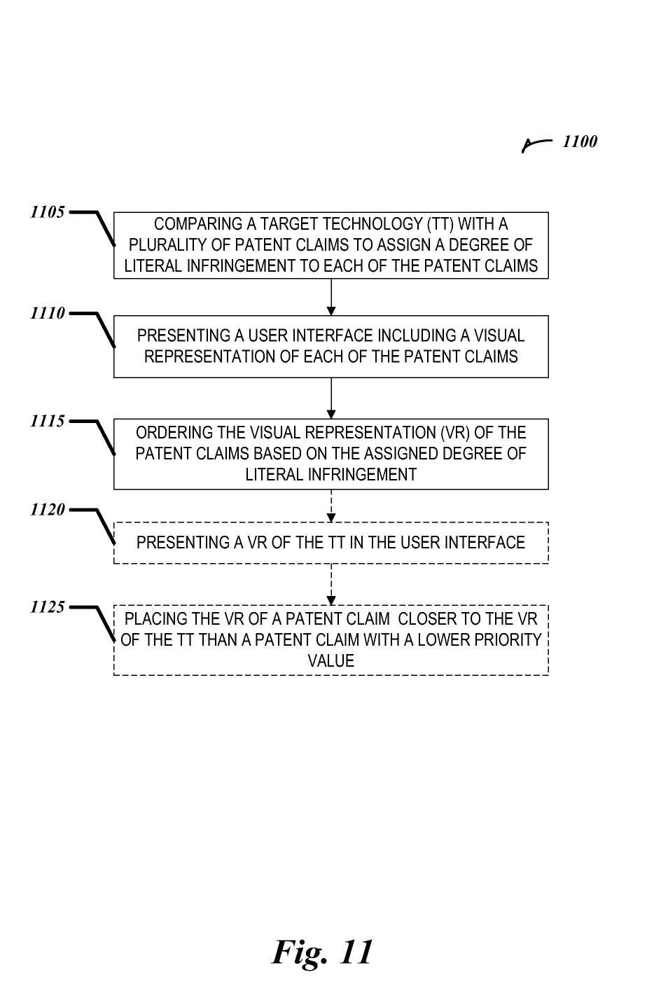

FIG. 11 illustrates an example method 1100 of ordering visual representations of claims in a claim matrix, according to one embodiment. In some examples, the method 1100 can include operations such as comparing a target technology 1105, presenting a user interface 1110, ordering the visual representation of the patent claims 1115, adding a visual representation of the target technology to the user interface 1120, and re-arranging the visual representations of the patents claims with respect to the target technology 1125.

At operation 1105, a target technology can be compared (e.g., by the comparing module 135) with a plurality of patent claims to assign a degree of literal infringement to each of the patent claims in the plurality of patent claims. In some examples, the target technology can include a set of claim elements (TT elements), and each of the patent claims includes a set of claim elements (PC elements). In other words, the target technology can be defined by the claim elements in the TT elements set, and a patent claim can be defined by the claim elements in the corresponding PC elements set.

In some examples, the degree of literal infringement for the patent claim is assigned to the patent claim based on the number of PC elements not in the TT elements. Note that if the target technology literally infringes the patent claim, then the PC element will be a subset of the TT elements and thus have zero PC elements not in the TT elements. This scenario can yield the highest degree of infringement (e.g., actual literal infringement). Further, the more PC elements that are not found in the TT elements, the harder it is for the target technology to infringe the patent claim even if the TT elements are modified. Accordingly, a lower degree of infringement is imputed to SC elements with larger numbers of elements not in the TT elements set. In some examples, the highest degree of literal infringement represents literal infringement of the patent claim by the target technology. In some examples, the degree of literal infringement for the patent claim can be further based on the number of PC elements in common with the TT elements where the PC elements are not a subset of the TT elements. Here, no literal infringement exists. However, some target technology claim elements are present in the patent claim. Thus, if two patent claims have three claim elements outside the TT elements set, but one patent claim has an element inside the TT elements set, this patent claim can be assigned a higher degree of infringement.

At operation 1110, a user interface can be presented (e.g., by the display module 110) that includes a visual representation of each of the plurality of patent claims (for example, the PC columns 510 shown in FIG. 5).

At operation 1115, the visual representation of each of the plurality of patent claims can be ordered (e.g., by the display module 110) based on the assigned degree of literal infringement.

At operation 1120, method 1100 can optionally include presenting (e.g., by the display module 110) a visual representation of the target technology in the user interface (for example, TT column 525 from FIGS. 4-7B). In some examples the user interface is a claim chart or claim matrix.

At operation 1125, method 1100 can optionally include placing (e.g., by the display module 110) a first visual representation of a first patent claim closer to the visual representation of the target technology than a second visual representation of a second patent claim where the first patent claim has a higher degree of literal infringement than the second patent claim. For example, referring to FIG. 5, Patent claim 1 has a higher degree of literal infringement than Patent claim 2, and so its corresponding column is placed closer to the target technology visual representation.

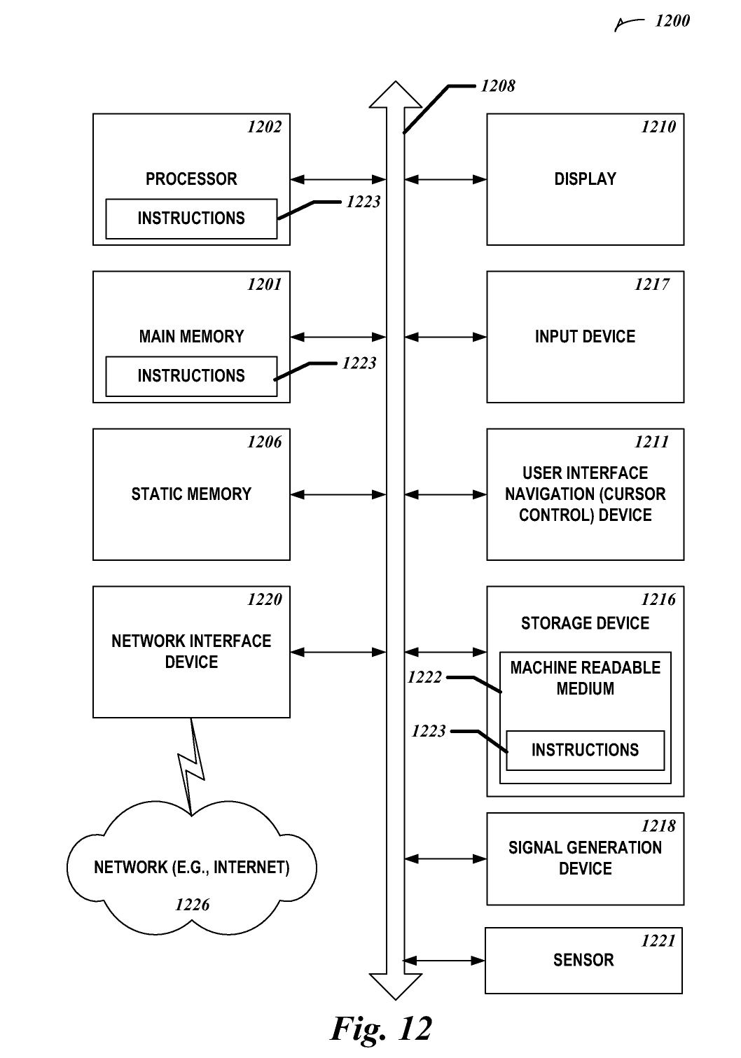

FIG. 12 illustrates a block diagram of an example machine 1200 upon which any one or more of the methodologies discussed can be run.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors can be configured by software (e.g., an application or application portion) as a hardware-implemented module that operates to perform certain operations as described herein.

In various examples, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple of such hardware-implemented modules exist contemporaneously, communications can be achieved through signal transmission (e.g., over appropriate circuits and buses) that connect the hardware-implemented modules. In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as “software as a service” (SaaS). For example, at least some of the operations can be performed by a group of computers (as examples of machines including processors), with these operations being accessible via a network (e.g., the Internet) and via one or more appropriate interfaces (e.g., Application Program Interfaces (APIs).)

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

FIG. 12 is a block diagram illustrating an example machine upon which any one or more of the methodologies herein discussed can be run. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1200 includes a processor 1202 (e.g., a central processing unit (CPU), a graphics processing unit (GPU) or both), a main memory 1201 and a static memory 1206, which communicate with each other via a bus 1208. The computer system 1200 can further include a display unit 1210, an alphanumeric input device 1217 (e.g., a keyboard), and a user interface (UI) navigation device 1211 (e.g., a mouse). In one embodiment, the display unit 1210, input device 1217 and UI navigation device 1211 are a touch screen display. The computer system 1200 can additionally include a storage device (e.g., drive unit) 1216, a signal generation device 1218 (e.g., a speaker), a network interface device 1220, and one or more sensors 1221, such as a global positioning system (GPS) sensor, compass, accelerometer, or other sensor.

The storage device 1216 includes a machine-readable medium 1222 on which is stored one or more sets of data structures and instructions 1223 (e.g., software) embodying or utilized by any one or more of the methodologies or functions described herein. The instructions 1223 can also reside, completely or at least partially, within the main memory 1201 and/or within the processor 1202 during execution thereof by the computer system 1200, with the main memory 1201 and the processor 1202 also constituting machine-readable media.

While the machine-readable medium 1222 is illustrated in an example embodiment to be a single medium, the term “machine-readable medium” can include a single medium or multiple media (e.g., a centralized or distributed database, and/or associated caches and servers) that store the one or more instructions 1223. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1223 can further be transmitted or received over a communications network 1226 using a transmission medium via the network interface device 1220 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

### Additional Example Embodiments

Example 1 includes receiving user input at a scope concept visual component to collapse one or more claim element visual components displayed as children to the scope concept visual component, evaluating claim elements corresponding to the one or more claim element visual components to determine a priority value for each claim element, and updating the scope concept visual component to include a summary of the claim elements based on the determined priority value for each claim element.

In Example 2, the subject matter of Example 1 can optionally be configured such that evaluating the claim elements includes adding a visual representation of a priority value for a corresponding claim element to the corresponding claim element visual component.

In Example 3, the subject matter of one or any combination of Examples 1-2 can optionally be configured such that updating the scope concept visual component includes changing the scope concept visual component to include the visual representation of the priority value for a highest priority value.

In Example 4, the subject matter of one or any combination of Examples 1-3 can optionally be configured such that updating the scope concept visual component includes changing the scope concept visual component to include the visual representation of the priority value for each claim element in proportion to a distribution of priority values in the claim elements.

In Example 5, the subject matter of one or any combination of Examples 1-7 can optionally be configured such that evaluating claim elements corresponding to the claim visual components to determine a priority value for each claim element includes assigning a highest priority value to claim elements corresponding to a patent claim literally infringed by a target technology, assigning a middle priority value to claim elements corresponding to the target technology and a second patent claim not literally infringed by the target technology, assigning a lower middle priority value to claim elements corresponding to the second patent claim and not the target technology, and assigning the lowest priority value to other claim elements.

In Example 6, the subject matter of one or any combination of Examples 1-5 can optionally be configured such that the visual representation of the priority value is red for the highest priority value, yellow for the middle priority value, green for the lower middle priority value, and transparent for the lowest priority value.

In Example 7, the subject matter of one or any combination of Examples 1-6 can optionally including receiving user input at the scope concept visual component to expand the claim element visual components and updating the scope concept visual component to remove the summary of the claim elements.

Example 8 can include, or can be combined with, the subject matter of one or any combination of Examples 1-7 to optionally include, subject matter (such as an apparatus, a system, a method, a means for performing acts, or a computer-readable medium including instructions that, when performed by the computer, cause the machine to perform operations) including a priority module configured to determine a priority value for each of one or more claim elements associated with a scope concept, a memory module, and a display module. The memory module includes a representation of each of the one or more claim elements, an un-collapsed representation of the scope concept, and a collapsed representation of the scope concept including a summary of the claim elements. The display module is configured to display, via a user interface, the un-collapsed representation of the scope concept and the representation of each of the one or more claim elements, hide the representation of each of the one or more claim elements in response to user input on the un-collapsed representation of the scope concept, and replace the un-collapsed representation of the scope concept with the collapsed representation of the scope concept.

In Example 9, the subject matter of Example 8 can optionally be configured such that the priority module determines the priority value for each of the one or more claim elements. The determination is made by assigning a highest priority value to claim elements corresponding to a patent claim literally infringed by a target technology, assigning a middle priority value to claim elements corresponding to the target technology and a second patent claim not literally infringed by the target technology, assigning a lower middle priority value to claim elements corresponding to the second patent claim and not the target technology, and assigning the lowest priority value to other claim elements.

In Example 10, the subject matter of one or any combination of Examples 8-9 can optionally be configured such that the representation of a claim element is red if the claim element is assigned the highest priority value, yellow if the claim element is assigned the middle priority value, green if the claim element is assigned the lower middle priority value, and transparent if the claim element is assigned the lowest priority value.

In Example 11, the subject matter of one or any combination of Examples 8-10 can optionally be configured such that the summary of the claim elements includes a representation of a claim element corresponding to a claim element assigned the highest priority.

In Example 12, the subject matter of one or any combination of Examples 8-11 can optionally be configured such that the summary of the claim elements includes a proportional representation of claim elements based on the prevalence of assigned priority values in corresponding claim elements.

In Example 13, the subject matter of one or any combination of Examples 8-12 can optionally be configured such that display module is configured to replace the collapsed representation of the scope concept with the un-collapsed representation of the scope concept in response to user input on the collapsed representation of the scope concept, and to un-hide the representation of each of the one or more claim elements.

Example 14, can include, or can be combined with the subject matter of one or any combination of Examples 1-13 to optionally include, a subject matter (such as an apparatus, a system, a method, a means for performing acts, or a computer-readable medium including instructions that, when performed by the computer, cause the machine to perform operations) of instructions, which when executed by a machine, cause the machine to receive user input at a scope concept visual component to collapse claim element visual components, evaluate claim elements corresponding to the claim visual components to determine a priority value for each claim element, and update the scope concept visual component to include a summary of the claim elements based on the determined priority value for each claim element.

Example 15, can include, or can be combined with the subject matter of one or any combination of Examples 1-14 to optionally include, a subject matter (such as an apparatus, a system, a method, a means for performing acts, or a computer-readable medium including instructions that, when performed by the computer, cause the machine to perform operations) of receiving, using one or more processors, a patent claim library including one or more patent claim elements; determining a target technology set including one or more claim elements associated with the target technology, with the target technology set being a non-empty subset of the patent claim library; determining a patent claim set corresponding to each of one or more patent claims, with the patent claim set including one or more claim elements associated with a corresponding patent claim and the patent claim set being a non-empty subset of the patent claim library; displaying, using one or more processors, a user interface including a matrix, wherein members of the patent claim library correspond to rows of the matrix (CE rows), a TT column corresponds with the target technology, and PC columns correspond with the one or more patent claims; and iterating through the CE rows. The iterating including, for each CE row in the CE rows, marking each cell of the CE row intersecting the TT column with a first symbol if the claim element corresponding to the CE row is in the target technology set; marking each cell of the CE row intersecting the TT column with a second symbol if the claim element corresponding to the CE row is not in the target technology set; marking each cell of the CE row intersecting a PC column with a third symbol, if the claim element is in the target technology set and the patent claim set corresponding to the PC column, and the patent claim set is a subset of the target technology set; marking each cell of the CE row intersecting the PC column with a fourth symbol, if the claim element is in the target technology set and the patent claim set, and the patent claim set is not a subset of the target technology set; and marking each cell of the CE row intersecting a PC column with a fifth symbol, if the claim element is not in the target technology set and the claim element is in the patent claim set.

In Example 16, the subject matter of Example 15 can optionally include receiving user input at the first symbol, removing the claim element from the target technology set, and reiterating through the CE rows.

In Example 17, the subject matter of one or any combination of Examples 15-16 can optionally include receiving user input at the second symbol, adding the claim element to the target technology set, and reiterating through the CE rows.

In Example 18, the subject matter of one or any combination of Examples 15-17 can optionally include iterating through SC rows of the matrix. The iterating including, for each SC row in the SC rows, marking each cell of the row intersecting the TT column with a sixth symbol if a scope concept set corresponding to the SC row is not-empty and the intersection between the scope concept set and the target technology set is also not-empty, and otherwise marking each cell of the SC row intersecting the TT column with a seventh symbol.

In Example 19, the subject matter of one or any combination of Examples 15-18 can optionally include receiving user input at the sixth symbol, removing claim elements from the target technology set in the intersection of the target technology set and the scope concept set, reiterating through the CE rows, and reiterating through the SC rows.

In Example 20, the subject matter of one or any combination of Examples 15-19 can optionally include receiving user input at the seventh symbol, adding claim elements in the scope concept set to the target technology set, reiterating through the CE rows, and reiterating through the SC rows.

In Example 21, the subject matter of one or any combination of Examples 15-20 can optionally be configured such that the third symbol alerts a user that the claim element is in a patent claim, corresponding to the patent claim set, literally infringed by a target technology corresponding to the target technology set.

In Example 22, the subject matter of one or any combination of Examples 15-21 can optionally be configured such that the third symbol is a red box filling the cell.

In Example 23, the subject matter of one or any combination of Examples 15-22 can optionally be configured such that the fourth symbol alerts a user that the claim element is in both a patent claim, corresponding to the patent claim set, and a target technology corresponding to the target technology set, wherein the target technology does not literally infringe the patent claim.

In Example 24, the subject matter of one or any combination of Examples 15-23 can optionally be configured such that the fourth symbol is a yellow box filling the cell.

In Example 25, the subject matter of one or any combination of Examples 15-24 can optionally be configured such that the fifth symbol alerts a user that the claim element is in a patent claim, corresponding to the patent claim set, and not in a target technology corresponding to the target technology set.

In Example 26, the subject matter of one or any combination of Examples 15-25 can optionally be configured such that the fifth symbol is a green box filling the cell.

Example 27 can include, or can be combined with the subject matter of one or any combination of Examples 1-26 to optionally include, subject matter (such as an apparatus, a system, a method, a means for performing acts, or a computer-readable medium including instructions that, when performed by the computer, cause the machine to perform operations) of an apparatus including a memory module; a display module configured to present a user interface including a matrix, wherein members of the patent claim library correspond to rows of the matrix (CE rows), a TT column corresponds with the target technology, and PC columns correspond with the one or more patent claims; and a marking module. The memory module includes a patent claim library including one or more patent claim elements, a target technology set including one or more claim elements associated with the target technology, with the target technology set being a non-empty subset of the patent claim library, and a patent claim set corresponding to each of one or more patent claims, with the patent claim set including one or more claim elements associated with a corresponding patent claim and the patent claim set being a non-empty subset of the patent claim library. Also, the marking module is configured to iterate through the CE rows including, for each CE row in the CE rows, to mark each cell of the CE row intersecting the TT column with a first symbol if the claim element corresponding to the CE row is in the target technology set, to mark each cell of the CE row intersecting the TT column with a second symbol if the claim element corresponding to the CE row is not in the target technology set, to mark each cell of the CE row intersecting a PC column with a third symbol, if the claim element is in the target technology set and the patent claim set corresponding to the PC column, and the patent claim set is a subset of the target technology set, to mark each cell of the CE row intersecting the PC column with a fourth symbol, if the claim element is in the target technology set and the patent claim set, and the patent claim set is not a subset of the target technology set, and to mark each cell of the CE row intersecting a PC column with a fifth symbol, if the claim element is not in the target technology set and the claim element is in the patent claim set.

In Example 28, the subject matter of Example 27 can optionally include a user input module. The user input module is configured to receive user input at the first symbol, remove the claim element from the target technology set, and invoke the marking module to reiterate through the CE rows.

In Example 29, the subject matter of one or any combination of Examples 27-28 can optionally include a user input module. The user input module is configured to receive user input at the second symbol, add the claim element to the target technology set, and invoke the marking module to reiterate through the CE rows.

In Example 30, the subject matter of one or any combination of Examples 27-29 can optionally include the marking module further configured to iterate through SC rows of the matrix. Iterating through the SC rows including, for each SC row in the SC rows, to mark each cell of the SC row intersecting the TT column with a sixth symbol if a scope concept set corresponding to the SC row is not-empty and a subset of the target technology set, and otherwise to mark each cell of the SC row intersecting the TT column with a seventh symbol.

In Example 31, the subject matter of one or any combination of Examples 27-30 can optionally include a user input module. The user input module is configured to receive user input at the sixth symbol, remove claim elements from the target technology set in the intersection of the target technology set and the scope concept set, and invoke the marking module to reiterate through the CE rows and SC rows.

In Example 32, the subject matter of one or any combination of Examples 27-31 can optionally include a user input module. The user input module is configured to receive user input at the seventh symbol, add claim elements from the target technology set in the intersection of the target technology set and the scope concept set, and invoke the marking module to reiterate through the CE rows and SC rows

In Example 33, the subject matter of one or any combination of Examples 27-32 can optionally be configured such that the third symbol alerts a user that the claim element is in a patent claim, corresponding to the patent claim set, literally infringed by a target technology corresponding to the target technology set.

In Example 34, the subject matter of one or any combination of Examples 27-33 can optionally be configured such that the third symbol is a red box filling the cell.

In Example 35, the subject matter of one or any combination of Examples 27-34 can optionally be configured such that the fourth symbol alerts a user that the claim element is in both a patent claim, corresponding to the patent claim set, and a target technology corresponding to the target technology set. The subject matter of Examples 27-34 can also optionally be configured such that the target technology does not literally infringe the patent claim.

In Example 36, the subject matter of one or any combination of Examples 27-35 can optionally be configured such that the fourth symbol is a yellow box filling the cell.

In Example 37, the subject matter of one or any combination of Examples 27-36 can optionally be configured such that the fifth symbol alerts a user that the claim element is in a patent claim, corresponding to the patent claim set, and not in a target technology corresponding to the target technology set.

In Example 38, the subject matter of one or any combination of Examples 27-37 can optionally be configured such that the fifth symbol is a green box filling the cell.

Example 39 can include, or can be combined with the subject matter of one or any combination of Examples 1-38 to optionally include, subject matter (such as an apparatus, a system, a method, a means for performing acts, or a computer-readable medium including instructions that, when performed by the computer, cause the machine to perform operations) of instructions, which when executed by a machine, cause the machine to receive a patent claim library including one or more patent claim elements; determine a target technology set including one or more claim elements associated with the target technology, with the target technology set being a non-empty subset of the patent claim library; determine a patent claim set corresponding to each of one or more patent claims, with the patent claim set including one or more claim elements associated with a corresponding patent claim and the patent claim set being a non-empty subset of the patent claim library; display, using one or more processors, a user interface including a matrix, wherein members of the patent claim library correspond to rows of the matrix (CE rows), a TT column corresponds with the target technology, and PC columns correspond with the one or more patent claims; and iterate through the CE rows. The instructions to iterate through the CE rows cause the machine to, for each CE row in the CE rows, mark each cell of the CE row intersecting the TT column with a first symbol if the claim element corresponding to the CE row is in the target technology set, mark each cell of the CE row intersecting the TT column with a second symbol if the claim element corresponding to the CE row is not in the target technology set, mark each cell of the CE row intersecting a PC column with a third symbol, if the claim element is in the target technology set and the patent claim set corresponding to the PC column, and the patent claim set is a subset of the target technology set, mark each cell of the CE row intersecting the PC column with a fourth symbol, if the claim element is in the target technology set and the patent claim set, and the patent claim set is not a subset of the target technology set, and mark each cell of the CE row intersecting a PC column with a fifth symbol, if the claim element is not in the target technology set and the claim element is in the patent claim set.

Example 40 can include, or can be combined with the subject matter of one or any combination of Examples 1-38 to optionally include, subject matter (such as an apparatus, a system, a method, a means for performing acts, or a computer-readable medium including instructions that, when performed by the computer, cause the machine to perform operations) of comparing a target technology with a plurality of patent claims to assign a degree of literal infringement to each of the patent claims in the plurality of patent claims, presenting a user interface including a visual representation of each of the plurality of patent claims, and ordering the visual representation of each of the plurality of patent claims based on the assigned degree of literal infringement.

In Example 41, the subject matter of Example 40 can optionally be configured such that the target technology includes a set of claim elements (TT elements), and each of the patent claims includes a set of claim elements (PC elements). The subject matter of Example 40 can also optionally be configured such that the degree of literal infringement for a patent claim is assigned to the patent claim based on the number of PC elements not in the TT elements, with the PC elements corresponding to the patent claim.

In Example 42, the subject matter of one or any combination of Examples 40-41 can optionally be configured such that the highest degree of literal infringement represents literal infringement of the patent claim by the target technology, with the PC elements being a subset of the TT elements.

In Example 43, the subject matter of one or any combination of Examples 40-42 can optionally be configured such that the degree of literal infringement for the patent claim is further based on the number of PC elements common with the TT elements where the PC elements are not a subset of the TT elements.

In Example 44, the subject matter of one or any combination of Examples 40-43 can optionally be configured such that ordering the visual representation of each of the plurality of patent claims includes presenting a visual representation of the target technology in the user interface and placing a first visual representation of a first patent claim closer to the visual representation of the target technology than a second visual representation of a second patent claim, wherein the first patent claim has a higher degree of literal infringement than the second patent claim.

In Example 45, the subject matter of one or any combination of Examples 40-44 can optionally be configured such that the user interface is a claim chart (e.g., claim matrix).

Example 46 can include, or can be combined with the subject matter of one or any combination of Examples 1-45 to optionally include, subject matter (such as an apparatus, a system, a method, a means for performing acts, or a computer-readable medium including instructions that, when performed by the computer, cause the machine to perform operations) of an apparatus with a comparing module configured to compare a target technology with a plurality of patent claims to assign a degree of literal infringement to each of the patent claims in the plurality of patent claims and a display module. The display module is configured to present a user interface including a visual representation of each of the plurality of patent claims and order the visual representation of each of the plurality of patent claims based on the assigned degree of literal infringement.

In Example 47, the subject matter of Example 46 can optionally be configured such that the target technology includes a set of claim elements (TT elements), each of the patent claims includes a set of claim elements (PC elements), and the degree of literal infringement for a patent claim is assigned to the patent claim based on the number of PC elements not in the TT elements, with the PC elements corresponding to the patent claim.

In Example 48, the subject matter of one or any combination of Examples 46-47 can optionally be configured such that the highest degree of literal infringement represents literal infringement of the patent claim by the target technology, with the PC elements being a subset of the TT elements.

In Example 49, the subject matter of one or any combination of Examples 46-48 can optionally be configured such that the degree of literal infringement for the patent claim is further based on the number of PC elements in common with the TT elements where the PC elements are not a subset of the TT elements.

In Example 50, the subject matter of one or any combination of Examples 46-49 can optionally be configured such that ordering the visual representation of each of the plurality of patent claims includes a visual representation of the target technology in the user interface and a first visual representation of a first patent claim placed closer to the visual representation of the target technology than a second visual representation of a second patent claim, wherein the first patent claim has a higher degree of literal infringement than the second patent claim.

In Example 51, the subject matter of one or any combination of Examples 46-50 can optionally be configured such that the user interface is a claim chart.

Example 52 can include, or can be combined with the subject matter of one or any combination of Examples 1-51 to optionally include, subject matter (such as an apparatus, a system, a method, a means for performing acts, or a computer-readable medium including instructions that, when performed by the computer, cause the machine to perform operations) of instructions causing a machine to compare a target technology with a plurality of patent claims to assign a degree of literal infringement to each of the patent claims in the plurality of patent claims. The instructions also cause the machine to present a user interface including a visual representation of each of the plurality of patent claims and to order the visual representation of each of the plurality of patent claims based on the assigned degree of literal infringement.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other examples or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a tangible computer-readable medium or tangible machine-readable medium encoded with instructions operable to configure an electronic device to perform methods as described in the above examples. An implementation of such methods can include code, such as microcode, assembly language code, a higher-level language code, or the like. Such code can include computer-readable instructions for performing various methods. The code can form portions of computer program products. Further, the code can be tangibly stored on one or more volatile or non-volatile computer-readable media during execution or at other times. These computer-readable media can include, but are not limited to, hard disks, removable magnetic disks, removable optical disks (e.g., CDs and DVDs), magnetic cassettes, memory cards or sticks, random access memories (RAMs), read only memories (ROMs), and the like.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A method comprising:
selecting, using one or more processors, a patent claim with a plurality of versions;
identifying a prior version of the patent claim, from the plurality of versions, that a target technology does literally infringe;
identifying a subsequent version of the patent claim, from the plurality of versions, that the target technology does not literally infringe, the subsequent version of the patent claim including at least one claim amendment in comparison with the prior version of the patent claim; and
notifying, based on identifying the subsequent version of the patent claim, a user that the target technology does not infringe the patent claim based on the doctrine of equivalents.

2. The method of claim 1, wherein notifying the user that the target technology does not infringe the patent claim based on the doctrine of equivalents includes displaying an indicator to the user via a user interface.

3. The method of claim 2, wherein displaying the indicator to the user includes displaying a chronology of the patent claim with a first visual indicator showing the prior version of the patent claim and a second visual indicator showing the subsequent version of the patent claim.

4. The method of claim 3, wherein displaying the chronology includes displaying a matrix with target technology components occupying one or more rows and the plurality of versions of the patent claim occupying two or more columns in chronological order; and
wherein the first visual indicator is placed at the intersection of a target technology component and the prior version of the patent claim and the second visual indicator is placed at the intersection of the target technology component and the subsequent patent claim.

5. The method of claim 4, wherein notifying includes displaying the first visual indicator in red and the second visual indictor in green.

6. The method of claim 1, wherein the target technology includes a first plurality of claim elements, the prior version of the patent claim includes a second plurality of claim elements, and the subsequent version of the patent claim includes a third plurality of claim elements;
wherein identifying the prior version of the patent claim includes determining that the second plurality of claim elements is a subset of the first plurality of claim elements; and
wherein identifying the subsequent version of the patent claim includes determining that the third plurality of claim elements is not a subset of the first plurality of claim elements.

7. The method of claim 6, further comprising:
receiving, from the user, a selection of claim elements;
replacing the first plurality of claim elements with the selection of claim elements;
reassessing literal infringement of the target technology against the prior version of the patent claim and the subsequent version of the patent claim based on the replaced first plurality of claim elements, the second plurality of claim elements, and the third plurality of claim elements; and
updating the notification to the user if the reassessment changes the literal infringement of the target technology to either the prior version of the patent claim or the subsequent version of the patent claim.

8. The method of claim 1, wherein selecting the patent claim includes presenting a claim matrix via a user interface;
wherein the claim matrix represents the target technology and one or more patent claims; and
wherein the claim matrix provides a first indicator and second indicator in the claim matrix, the first indicator signifying that the target technology does not literally infringe the patent claim, and the second indicator signifying that the target technology does not infringe the patent claim based on the doctrine of equivalents.

9. A system including:
a Doctrine of Equivalents (DOE) module configured to:
receive a plurality of patent claim versions for a patent claim, the plurality of patent claim versions including a plurality of versions of the patent claim; and
receive a target technology definition for a target technology; and
generate a DOE indication based on the plurality of versions of the patent claim and the target technology definition, the DOE indication being a first type if the target technology does not infringe the patent claim under the DOE and the DOE indication being of a second type otherwise; and
a display module communicatively coupled to the DOE module and configured to present a user interface, the user interface including a visual indicator of the DOE indication.

10. The system of claim 9, wherein the DOE module is further configured to:
identify a target technology set (TT set) in the target technology definition, the TT set including one or more claim elements; and
identify a patent claim version set (PCV set) corresponding to each patent claim version in the plurality of patent claim versions, each PCV set including one or more claim elements.

11. The system of claim 10, wherein the DOE module is configured to:
generate the DOE indication of the first type including an identification of a first patent claim version;
receive a second patent claim version from the plurality of patent claim versions; and
determine that the target technology literally infringes the first patent claim version;
determine that the target technology does not literally infringe the second patent claim version; and
determine that the first version of the patent claim chronologically precedes the second version of the patent claim.

12. The system of claim 10, wherein the display module is further configured to display the user interface further including:
a matrix with rows of the matrix corresponding to a PCV library set, the PCV library set including one or more claim elements, the TT set and the PCV sets being subsets of the PCV library set;
a target technology column corresponding to the target technology;
an inclusion indicator at the intersection of a first row and the target technology column, the first row corresponding to a claim element in the PCV library set and the TT set;
a plurality of patent claim version columns, each patent claim version column in the plurality of patent claim version columns corresponding to a patent claim version in the plurality of patent claim versions, the patent claim version columns being arranged based on a chronological order of corresponding patent claim versions;
a visual indicator at the intersection of a second row and a patent claim version column from the plurality of patent claim version columns;
wherein the visual indicator is a first type of visual indicator if a claim element corresponding to the second row is in an intersection of the TT set and a PCV set corresponding to the patent claim version column and the PCV set is a subset of the TT set;
wherein the visual indicator is a second type of visual indicator if the claim element is in the intersection of the TT set and the PCV set and the PCV set is not a subset of the TT set; and
wherein the visual indicator is a third type of visual indicator if the claim element is in the PCV set and not in the TT set.

13. The system of claim 12, wherein the first type of visual indicator is red, the second type of visual indicator is yellow, and the third type of visual indicator is green.

14. The system of claim 12, wherein the display module is further configured to present the user, via a second user interface, a claim chart;
wherein the claim chart includes one or more patent claim visual components;
wherein each patent claim visual component in the one or more patent claim visual components corresponds to a final patent claim version in a plurality of patent claims;
wherein each patent claim visual component includes a DOE visual component; and
wherein the DOE visual component displays a summary of the DOE indication.

15. The system of claim 14, wherein the display module is further configured to present the user interface in response to the user selecting the DOE visual component.

16. The system of claim 14, wherein the claim chart further includes a library set, the library set including one or more claim elements;
wherein the claim chart includes a claim element selection interface configured to accept claim element selections from the library set for inclusion in the TT set; and
wherein the DOE module is configured to re-generate the DOE indication based on changes to the TT set.

17. A non-transitory computer readable medium including instructions, which when executed by a machine, cause the machine to:
determine a patent claim that a target technology does not literally infringe;
determine a prior version of the patent claim that the target technology does literally infringe; and
present a user interface indicating that the target technology does not infringe the patent claim based on the doctrine of equivalents.

18. The computer readable medium of claim 17, wherein the instructions that cause the machine to present further include instructions that cause the machine to present the user interface including a representation of a first plurality of claim elements included in the patent claim, a second plurality of claim elements included in the prior version of the patent claim, and a third plurality of claim elements included in the target technology; and
wherein a first visual indicator represents the second plurality of claim elements, a second visual indicator represents the first plurality of claim elements that are common with the third plurality of claim elements, and a third visual indicator represents the first plurality of claim elements that are not common with the third plurality of claim elements.

19. The computer readable medium of claim 18, further comprising instructions that cause the machine to:
update the target technology's claim elements in response to user input;
determine that the target technology does not literally infringe the patent claim based on the updated target technology claim elements;
determine that the target technology does literally infringe the prior version of the patent claim based on the updated target technology claim elements; and
re-present the user interface.

20. The computer readable medium of claim 17, further comprising instructions that cause the machine to:
present a visual claim element in a claim chart; and
wherein the visual claim element corresponds to the patent claim in the claim chart.

21. The computer readable medium of claim 20, wherein the instructions that cause the machine to present further include instructions that cause the machine to present the user interface in response to receipt of user input on the visual claim element.
